(19) United States
(12) Patent Application Publication
(10) Pub. No.: US 2024/0403668 A1
(43) Pub. Date: Dec. 5, 2024

(54) Application Prototyping Systems And Methods

(71) Applicant: Kinara, Inc., Los Altos, CA (US)

(72) Inventors: Abhilash Bharath Ghanore, Hyderabad (IN); Suresh Lakshmi Goduguluru, Hyderabad (IN); Rajashekar Reddy Ereddy, Hyderabad (IN); Sreenivas Aerra Reddy, San Jose, CA (US); Satya Uppalapati, Hyderabad (IN); Lava Kumar Bokam, Hyderabad (IN); Siva Kumar Vemuri, Hyderabad (IN); Arindam Chakraborty, Hyderabad (IN); Snigdha Alkanti, Hyderabad (IN); Divyansh Agrawal, Hyderabad (IN); Amit Pandey, Hyderabad (IN)

(21) Appl. No.: 18/325,553

(22) Filed: May 30, 2023

(51) Int. Cl. G06N 5/04; G06F 8/20

(52) U.S. Cl. CPC G06N 5/04; G06F 8/20

(57) ABSTRACT

Application prototyping systems and methods are disclosed. One aspect is a processing method for multiple computing devices that includes identifying resource constraints for the multiple computing devices. Using identified resource constraints, multiple presentation models at least in part based on identified processing metrics are created. In one aspect, the multiple presentation models include multiple processing pipelines configurable for execution on multiple computing devices. An inference engine can be used to provide an execution model for the multiple processing pipelines based at least in part on the multiple presentation models, with the execution model having improved processing metrics as compared to at least one of the multiple presentation models.

### BACKGROUND

### Technical Field

The present disclosure relates to systems and methods configured to create a set of one or more presentation models based on a system design and associated resource constraints, and execute one presentation model using an inference engine.

### Background Art

Contemporary multiprocessor system architecture design methodologies rely on a manual, user-involved approach. For example, a typical AI model compiler or mapper software development kit (SDK) reports inferences-per second (IPS) for each model when they are compiled offline (for example, in a single-model use case), based on user-defined architectures. The SDK does not consider, and is not aware of, an associated application stack or host functions involved for an end-to-end use-case. Other performance aspects such as input/output (IO) transfers, pre-processing, post-processing input and output transfer times (to and from a digital video device and a host), and to pipeline proxy inference pipeline may not be accounted for. Actual implementations of user-defined multiprocessing architectures may provide lower-than-predicted performance in an actual end-to-end system deployment. Contemporary multiprocessor system design techniques place the burden on the end user to come up with an appropriate pipeline execution model to achieve a desired hardware throughput.

### SUMMARY

Aspects of the invention are directed to systems and methods to execute a presentation model by an inference engine.

One aspect includes identifying resource constraints for multiple computing devices. Using identified resource constraints, a presentation model having a plurality of modifiable parameters based at least in part based on resource constraints may be created. One or more inference engines may be used to execute a particular neural network model, where an inference engine supports neural network processing.

Another aspect includes identifying resource constraints for multiple computing devices. Using identified resource constraints, multiple presentation models may be created. The presentation models may be created at least in part based on identified processing metrics, with the multiple presentation models including multiple processing pipelines configurable for execution on multiple computing devices. An inference engine may be used to provide an execution model for the multiple processing pipelines based at least in part on the multiple presentation models. In one aspect, the execution model has improved processing metrics as compared to at least one of the multiple presentation models.

Aspects of the invention include apparatuses that implement the above methods.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an embodiment of a pipeline processing system.

FIG. 2 is a block diagram depicting an embodiment of a pipeline processing architecture generator interface.

FIG. 3 is a block diagram depicting a mapping from an inference pipeline to compute resources.

FIG. 4 is a sequential execution flow diagram depicting a sequential execution flow.

FIG. 5 is a task flow diagram depicting a task flow.

FIG. 6 is an execution flow diagram depicting an execution flow.

FIG. 7 is an execution flow diagram depicting a parallel execution flow.

FIG. 8 is an execution flow diagram depicting an improvement in execution time.

FIG. 9 is a task flow diagram depicting a task flow.

FIG. 10 is an execution flow diagram depicting an execution flow.

FIG. 11 is a schematic diagram depicting a domain-specific language user interface.

FIG. 12 is an execution flow diagram depicting an inference use case.

FIG. 13 is an execution flow diagram depicting a resource allocation.

FIG. 14A is an execution flow diagram depicting a simulator application.

FIG. 14B is an execution flow diagram depicting parallel streams.

FIG. 15 is a schematic diagram depicting a memory allocation table.

FIG. 16 is an execution flow diagram depicting multiple execution stages in a model.

FIG. 17A is a schematic diagram depicting a presentation model.

FIG. 17B is a schematic diagram depicting an execution model.

FIG. 18A is a schematic diagram depicting a presentation model.

FIG. 18B is a schematic diagram depicting a presentation model.

FIG. 18C is a schematic diagram depicting a serially-merged presentation model.

FIG. 19A is a schematic diagram depicting a pair of presentation models.

FIG. 19B is a schematic diagram depicting a serially-merged execution model.

FIG. 20 is a schematic diagram depicting a pair of presentation models merged in parallel.

FIG. 21A is a schematic diagram depicting a pair of presentation models and a sink.

FIG. 21B is a schematic diagram depicting a parallel execution model.

FIG. 22 is a block diagram depicting an execution flow over a network.

FIG. 23 is a block diagram depicting an embodiment of a processing system.

FIG. 24 is a flow diagram depicting a method to provide an execution model.

FIG. 25 is a flow diagram depicting a method to execute a neural network model.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Aspects of the invention described herein address the shortcomings associated with contemporary multiprocessor system implementations. The systems and methods described herein facilitate the pipelining of the stream processing functions associated with, for example, streaming media applications. Some aspects provide a mechanism to order the stream processing functions, and may enable designing higher-order applications based on applications with relatively low complexity.

Some aspects may be configured to autonomously identify one or more performance constraints (e.g., bandwidth constraints, latency constraints, system processing constraints, etc.) associated with a multiprocessor architecture and one or more associated processing pipelines. Some embodiments may provide analytical information on performance gains or losses associated with moving one or more workloads across a spectrum of computing devices (i.e., across different computing devices in the multiprocessor system). One aspect may support a domain-specific language DSL to specify a pipeline functionality. Another aspect may provide a user interface (UI) for building a pipeline using one or more widgets and a gallery.

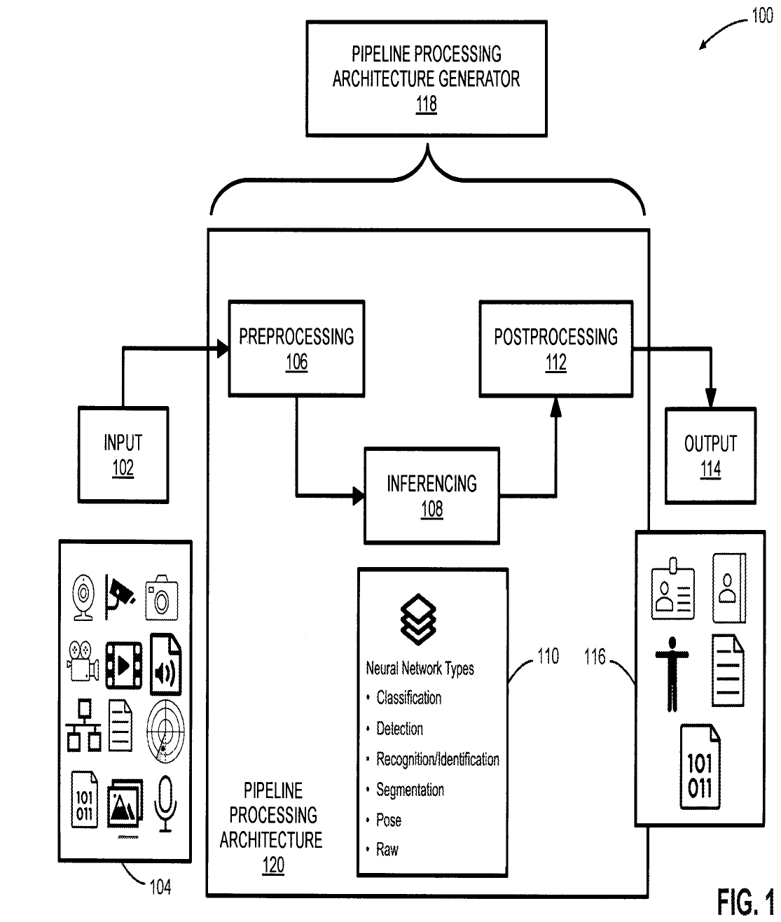

FIG. 1 is a block diagram depicting an embodiment of a pipeline processing system 100. As depicted, pipeline processing system 100 includes pipeline processing architecture generator 118, input 102, pipeline processing architecture 120, data sources 104, output 114, and data sinks 116.

Pipeline processing architecture 120 further includes preprocessing 106, inferencing 108, and postprocessing 112. Inferencing 108 may further include machine learning 108. In one aspect, data sources 104 are sources of digital data. Examples of digital data files include text files, audio files, video files, etc. Another aspect may include data sources 104 configured as video streaming sources (e.g., video cameras, webcams, security cameras, etc.). Other examples of data sources include online media files (e.g., streaming video from a website such as YouTube), radar data, streaming digital music, a digitized audio signal from a microphone, etc. Digital data generated by data sources 104 may be input to pipeline processing architecture 120 as input 102. Other sources to input 102 may include one or more cameras, files or directories, still images, video sources, one or more decoders, one or more real time streaming protocol (RTSP) or network sources, etc.

In one aspect, preprocessing 106 performs preprocessing functions on data received from input 102. Examples of preprocessing functions on video or image data include resizing, cropping, scaling, element-wise division, color-space conversion, mean subtraction, normalization, mirror imaging, transposing, tiling, input quantization, etc.

In one aspect, inferencing 108 is implemented using one or more processing systems that include any combination of artificial intelligence, neural network, and machine learning algorithms. Inferencing 108 may implement one or more of the following operations:
Inference submission: A dataset is input to inferencing 108 for processing.
Queue wait: Inferencing 108 may put the processing of the dataset on hold till processing on a previous dataset is complete.
Input transfer: Inferencing 108 may transfer the input dataset to one or more neural processing engines included in inferencing 108.
Inference execution: The neural processing engines may perform the following operations 110 associated with artificial intelligence and machine learning operations:
   Classification
   Detection
   Recognition/Identification
   Segmentation
   Pose detection
   Raw data classification
Output transfer: Transferring an output of the inference execution to output 114.
Load balancing: Balancing/redistributing computing load between different

processors in the multiprocessing system based on processor loading and computing resource usage.
Loading/unloading models: Loading or unloading one or more execution models to/from the multiprocessor system and the associated neural processing engines.

Postprocessing 112 may perform postprocessing operations on processed output data from inferencing 108. Post processing 112 may implement functions such as one or more detection layers, arithmetic functions such as sigmoid, softmax, and exponential, data sorting functions, converting one or more data vectors into corresponding text words or audio signals, dequantization, and so on. Results from postprocessing 112 may be received by output 114. Output 114 may perform one or more final operations on postprocessed data received from postprocessing 112. Such operations may include:
Generating one or more text overlays on the output data (for example, if the output data is an image, an image sequence, or a video stream).
Generating a two-dimensional or three-dimensional detection box (e.g., image or video files including face detection).
Instance and semantic segmentation.
Stitching output tiles (e.g., image or video stitching).
Pose/skeleton overlay on an object or person of interest.
Multi-stream compositing.
Cityscapes for driving.
Lane detection.
Three-dimensional car detection.

Outputs from output 114 may be transmitted to sink 116. Sink 116 may be a user

interface that is configured to present or display results from output 114. Examples of sink 116 may include any combination of visual display monitors (e.g., computer or television screens), audio devices (e.g., buzzers or loudspeakers), lamps or LED lights, and so on. Results from output 114 may be displayed as a text file, an image file, a video stream, an audio or sound stream, and so on.

In one aspect, pipeline processing architecture may include an accuracy metric stage (not depicted), after postprocessing 112 and before output 114. Accuracy metrics associated with the accuracy metric stage may include numerical accuracy (i.e., range, precision and error). The accuracy metric stage may be configured to perform on-the-fly updating of any accuracy metrics associated with pipeline processing architecture 120. Examples of metrics include a latency, an execution time, a memory consumed, an input/output data transfer time, and an inference time.

In one aspect, pipeline processing architecture 120 may be configured to perform processing operations using pipelining, or pipeline processing. Examples of pipelines include an audio stream pipeline, a video stream pipeline, and so on. In stream processing applications (e.g., audio or video stream processing), a pipeline, also known as a data pipeline, is a set of a data processing elements connected in series, where the output of one element is the input of the next element. The elements of a pipeline are often executed in parallel or in a time-sliced fashion. Pipeline models may be used to increase throughput. An ideal throughput of a pipelined processing system is same as the input rate. To bring the stream processing application output to the levels of the input, the same execution sequence of stream processing functions, (e.g., lines) are run multiple times in parallel. The number of lines to run in parallel depends on the latency/processing time of the stream processing functions.

In one aspect, a processing architecture for pipeline processing architecture 120 is generated by pipeline processing architecture generator 118. Pipeline processing architecture generator 118 may generate one or more candidate multiprocessing system architectures (also referred to as “multiprocessing system configurations”) that can be used to implement pipeline processing architecture 120. Based on processing parameters (e.g., desired latency, available computational and memory resources, etc.) pipeline processing architecture generator 118 may generate one or more multiprocessing system configurations that may be used to implement pipeline processing architecture 120. Of these multiprocessing system configurations, a user may select one multiprocessing system configuration to implement pipeline processing architecture 120.

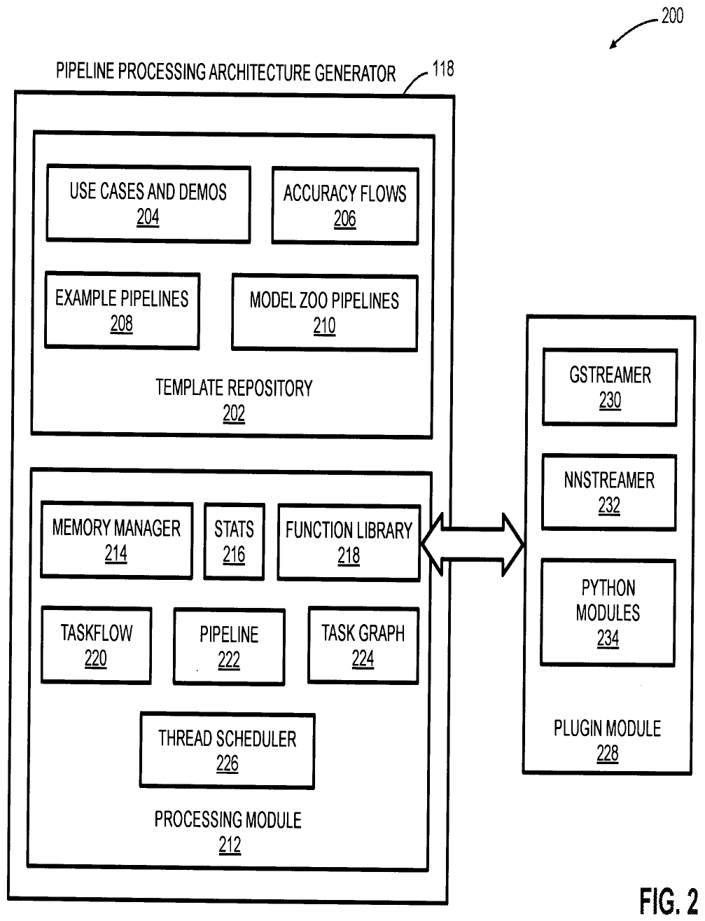

FIG. 2 is a block diagram depicting an embodiment of a pipeline processing architecture generator interface 200. As depicted, pipeline processing architecture generator interface 200 includes pipeline processing architecture generator 118, and plugin module 228. Pipeline processing architecture generator 118 further includes template repository 202, and processing module 212. Template repository 202 further includes use cases and demos 204, accuracy flows 206, example pipelines 208, and model zoo pipelines 210. Processing module 212 further includes memory manager 214, statistics 216 (depicted in FIG. 2 as stats 216), function library 218, taskflow 220, pipeline 222, task graph 224, and thread scheduler 226. Plugin module 228 further includes gstreamer 230, nnstreamer 232, and Python modules 234.

Pipeline processing architecture generator 118 may be configured to receive a design specification for a multiprocessing system. The design specification may include functionality (e.g., face detection or object tracking), a number of pipeline stages, a listing of the pipeline stages and their order, and other such information. The design specification may also include available system resources (e.g., number of CPUs, number of GPUs, system memory (RAM), etc.). The design specification may also include a requirement that a particular aspect of system design or system performance be given priority. For example, a first user may want to use as less computing resource utilization as possible in a first design, a second user may want to reduce latency in a second design, and so on.

To ensure that certain minimum systemic and performance objectives are maintained, the design specification may also include one or more constraints. For example, while trying to increase system throughput, a processing resource utilization constraint may impose an associated limit based on available computing resources (e.g., a limited number of processing cores). Or, while trying to reduce system resource utilization, the throughput of the system should not drop below a certain value. Pipeline processing architecture generator 118 may receive the system design requirements along with the constraints, and generate one or more multiprocessing system designs (i.e., multiprocessing system configurations or multiprocessing system architectures) based on the performance requirements and constraints. A user may then select one of these multiprocessing system designs to implement as pipeline processing architecture 120.

In one aspect, processing module 212 includes components that perform the generation of the multiprocessing system designs. In one aspect, these design specifications are referred to as “presentation models.” Memory manager 214 may process data associated with the design specification to ensure that a multiprocessing system architecture is within any memory constraints specified by the multiprocessing system design specification.

In one aspect, statistics 216 is configured to gather statistics either statically from an input design specification, or at run time. Statistics 216 may gather statistics by querying various components in the system to obtain information such as memory consumed for a particular operation, time consumed for a particular configuration, etc. Taskflow 220 may be configured to provide a capability to traverse and execute one or more Task Graphs. In one aspect, task graph 224 allows for representation of a set of execution elements in a graph format i.e., in a specific order, say a DAG (directed acyclic graph). Pipeline 222 allows for representation of a set of pipestages are eventually traversed and executed in a sequential manner. A pipestage is a logical grouping of ‘related’ tasks that together represent a high level function that is performed, for example ‘pre-processing’ stage.

Function library 218 may be configured to interface with plugin module 228. Plugin module 228 may include modules such as Gstreamer 230, nnstreamer 232, and other Python modules. The modules included in plugin module 228 may be external modules that the system can avail of in order to implement one or more functions (e.g., a resize function in a pre-processing stage). External frameworks such as GStreamer can provide alternate representations that pipeline processing architecture generator 118 can leverage to implement such functions. An abstract representation of these functions may be provided as one or more inputs to pipeline processing architecture generator 118 in order to use these functions appropriately.

In one aspect, template repository 202 includes one or more system architecture templates that can be used by a user to generate a multiprocessing system design (architecture). Use cases and demos 204 may include multiprocessing design architectures for specific use cases, as well as demonstration multiprocessing system design architectures that may be used to demonstrate the capabilities of pipeline processing architecture generator 118. Accuracy flows 206 is a set of templates that can include additional pipe stages, as opposed to functional variants of pipelines such as Demos. These additional pipe stage perform functions such as configuration, observation and reporting of numerical accuracy statistics. In one aspect, numerical accuracy data is used to determine if a particular use case is able to accurately perform the function and if not, how much the deviation is for a predetermined function like Mean Intersection over Union (MIOU) from the predetermined or acceptable value for any deviations.

In one aspect, example pipelines 208 includes sample pipeline architectures that can be used by a user to as learning tools or as multiprocessing system architectures on which a multiprocessing system architecture can be based. In one aspect, model zoo pipelines 210 are fully-functional, simplistic representations of a pipeline. For example, in one such implementation, a model zoo pipeline may perform all steps sequentially (e.g., one-by-one) while dumping parameters, input and output and data at each and every stage or step of the pipeline, pipe stage or task. Such a representation allows for a user to easily understand, visualize and debug the pipeline or task. Model zoo pipelines 210 may also be used to demonstrate the capability of a particular machine learning model without the complexities of a performant implementation of the same.

In general, a stream processing paradigm simplifies parallel software and hardware by restricting the parallel computation that can be performed by a multiprocessing system architecture. Given a sequence of data (e.g., a stream), a series of operations is applied to each element in the stream. Kernel functions are usually pipelined, and local on-chip computing functionality and memory reuse is attempted, in order to reduce or minimize the loss in bandwidth. Uniform streaming, where same set of kernel functions are applied to all elements in the stream, is typical. Pipeline processing architecture generator 118 may be viewed as a framework that:
Facilitates the pipelining of the stream processing functions.
Provides a mechanism to order the stream processing functions.
Facilitates a construction of a higher order applications by constituting simple applications.
Helps in identifying the system performance degradation (e.g., bottlenecks) in the pipeline processing.
Provides hints on moving the workloads across the spectrum of computing devices.
Provides a domain-specific language (DSL) to specify the pipeline functionality.
Provides a user interface (UI) for building the pipeline using widgets and a gallery.

Pipeline models may be used mainly to increase the throughput of a

multiprocessing system architecture; the ideal throughput is same as the input rate. To bring the stream processing application output to the levels of the input, the same execution sequence of stream processing functions is run. In other words, a “line” of tasks is run multiple times in parallel. The number of lines to run in parallel depends on the latency/processing time of the stream processing functions.

In one aspect, the following concepts may be associated with pipeline processing architecture generator 118:
An application may include one or more models
A model is a pipeline that can run independently
A pipeline is a sequential execution of stages
A stage is logical grouping of stream processing steps
A step is the lowest level item, an item that holds the actual processing function.
Generating a system architecture to run an inference pipeline is a possible use case of pipeline processing architecture generator 118.

In one aspect, pipeline processing architecture generator 118 facilitates building an inference pipeline from scratch, and/or facilitates building a prototypes of use cases. In one aspect, pipeline processing architecture generator 118 may be equipped with metrics collection system (e.g., statistics 216), and may collect the memory and CPU at task, stage and line levels. (e.g., using memory manager 214 and other modules). For an inference stage, pipeline processing architecture generator 118 may collect data transfer time and inference time. Pipeline processing architecture generator 118 may provide tools to analyze and identify the performance degradation points (e.g., bottlenecks) in the pipeline execution. Pipeline processing architecture generator 118 may also provide a mechanism to offload the execution of a step on to any generic or specialized hardware present on a host (e.g., a host computing system).

While building an app (e.g., an application software or a multiprocessing system design architecture), maintain two aspects may be taken into consideration: a composition of a pipeline and an execution of the pipeline.

Pipeline composition may be considered a building mode. After analyzing the application, a logical grouping of associated functionalities may be performed. Each such group is called a stage. Inter-step dependencies determine the possibility of parallel execution of the steps in the stage. The stages in a pipeline are always executed in sequential order. For example, input 102, preprocessing 106, inferencing 108, post-processing 112 (also referred to as “postprocessing 112”), and output 114 are stages. Operations such as resize, crop, shift, pad and quantize are steps. Based on their order in the data address generator (DAG), shift and pad steps can be executed in parallel. Stages 102 through 114 may be executed sequentially within a given pipeline instance.

In one aspect, pipeline processing architecture generator 118 may be deployed as a software application running on a host computing system. A selected multiprocessing system architecture may be deployed as pipeline processing architecture 120. Pipeline processing architecture 120 may be run on a target computing system that may include any combination of multi-core CPUs, multi-core GPUs, system memory, multi-core custom hardware accelerators, neural processing units (NPUs), deep learning accelerators (DLAs), FPGA-based custom accelerators, and one or more wired or wireless network connections. In one aspect, the target computing system may be implemented as a customized processing integrated circuit. The target computing system may include inferencing 108, which may further include machine learning or artificial intelligence components such as neural engines, convolutional neural networks, and neural network models.

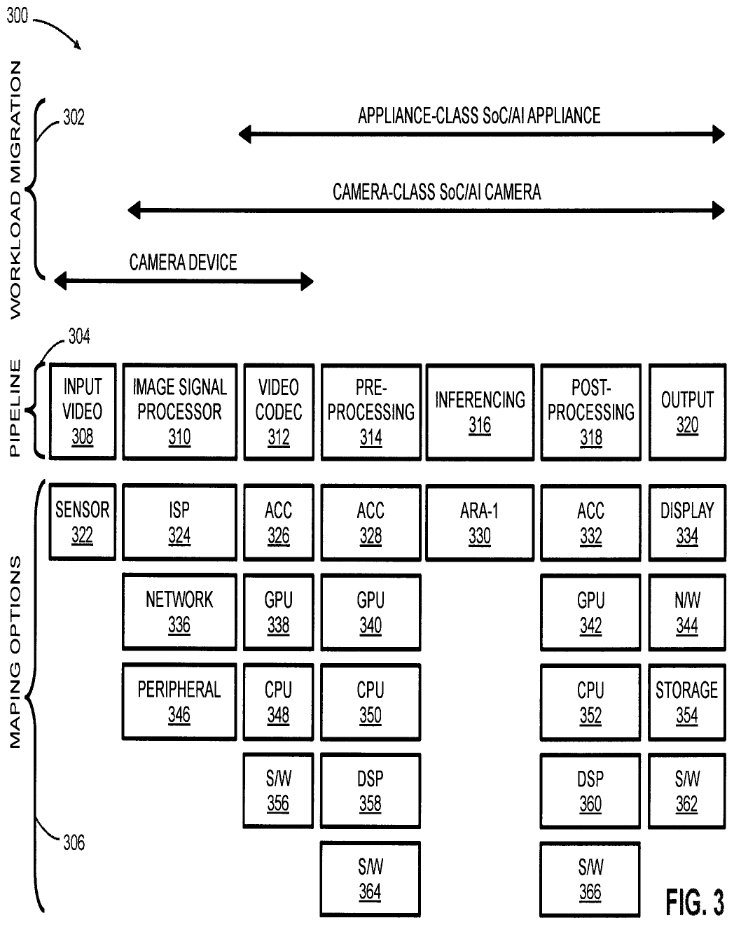

FIG. 3 is a block diagram depicting a mapping 300 from an inference pipeline to compute resources. Mapping 300 As depicted, mapping 300 includes workload migration 302, pipeline 304, and mapping options 306. Pipeline 304 may include a plurality of stages-input video 308, image signal processor 310, video codec 312, preprocessing 314, inferencing 316, post-processing 318, and output 320. Of these stages, stages 308 through 312 may be implemented on a camera device, as indicated by workload migration 302. Workload migration 302 also provides options for stages 310 through 320 to be implemented on, for example, a system-on-chip (SoC) AI camera. Workload migration 302 also provides options for stages 312 through 320 to be implemented on, for example, an appliance-class SoC or AI Appliance such as an ARM Cortex SoC,.

In one aspect, stages 308 through 312 may correspond to input stage 102. Input video 308 may be generated by a video source such as a digital camera. Image signal processor 310 may relate to image processing functions implemented on the digital camera. The digital camera may also have a video codec stage 312. Stages 314, 316, 318, and 320 may be respectively similar to preprocessing 106, inferencing 108, postprocessing 112, and output 114.

Mapping options 306 provide different options that each stage can be mapped to (e.g., associated with, generated by, or executed on). Input video 308 may be generated by sensor 322. Sensor 322 may be an image sensor (e.g., a CCD sensor or a CMOS sensor or some other type of image sensor) in a digital camera or digital imaging device. Image signal processor 310 may be mapped to any combination of an image signal processor (ISP) 324, to a network 336, or to a peripheral 346. When an input source (e.g., input video 308 or sensor 322) is via network 336, a network interface card in the system is configured to receive or retrieve the corresponding input source data. For example, a camera in an industrial installation, say at a door, will stream the video data via a protocol such as RTSP (real-time streaming protocol), via network 336. An application may subscribe to the RTSP stream in order to execute 336. Similarly, a peripheral could be a USB camera which is connected to the USB port of the system. The application can invoke a USB camera driver and issue corresponding requests for video frames in order to execute peripheral stage 346. Video codec 312 may be mapped to any combination of a hardware accelerator 326, one or more GPUs 338, one or more CPUs 348, or to software 356. Any combination of these blocks can provide video codec functionalities.

In one aspect, mapping options 306 map inferencing 316 to a customized integrated circuit Ara-1 330. Ara-1 330 may be implemented as a computing system with one or more multi-core CPUs, one or more GPU arrays, system memory, and a network connection. Ara-1 may be a target computing system configured to run a multiprocessing system architecture generated by pipeline processing architecture generator 118. Post-processing 318 may be mapped by mapping options 306 to any combination of a hardware accelerator 332, one or more GPUs 342, one or more CPUs 352, one or more DSPs 360, or software 366. Mapping options 306 can map output 320 to display 334 (e.g., a video display), a network 344, a storage 354 (e.g., a hard disk drive or a cloud storage server), or to software 362.

In one aspect, network 336 and network 344 may be implemented via software. Boundaries associated with allocated stages in workload migration 302 may have fluid boundaries based on selected components, component feature set, cost, power, scalability etc.

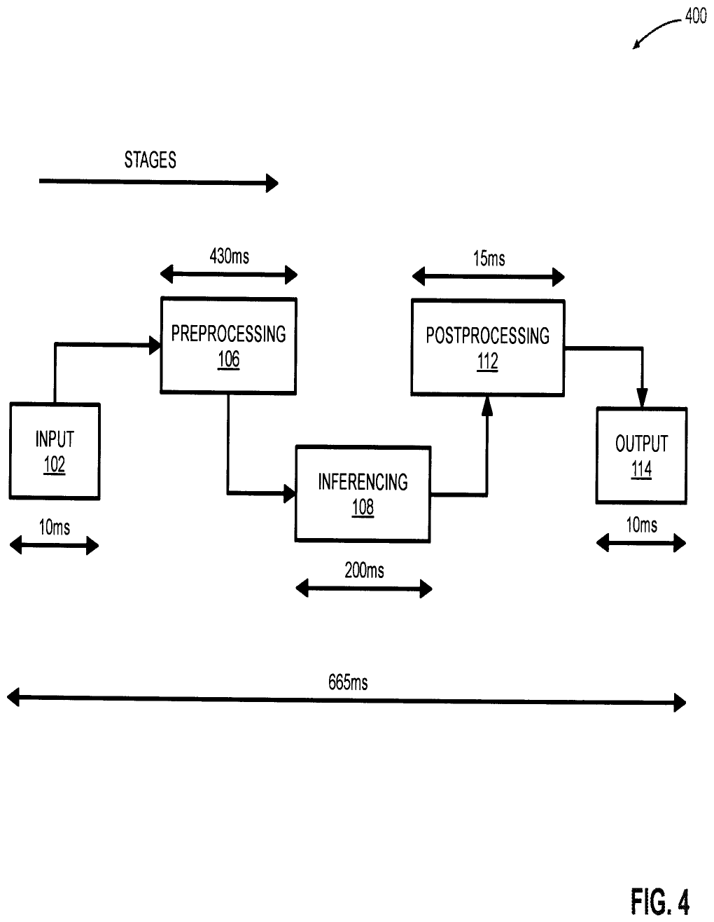

FIG. 4 is a sequential execution flow diagram depicting a sequential execution flow 400. As depicted, flow 400 represents a pipeline that includes multiple stages-input 102, preprocessing 106, inferencing 108, postprocessing 112, and output 114. These stages, executed sequentially for the pipeline, respectively require 10 ms, 430 ms, 200 ms, 15 ms, and 10 ms to complete, for a total completion time (i.e., an end-to-end latency) of 665 ms for the pipeline. Based on this end-to-end latency, an associated throughput for the pipeline is approximately 1.5 inferences/second. This implementation may consume 1 unit of memory, with 1 active thread, for a single pipeline.

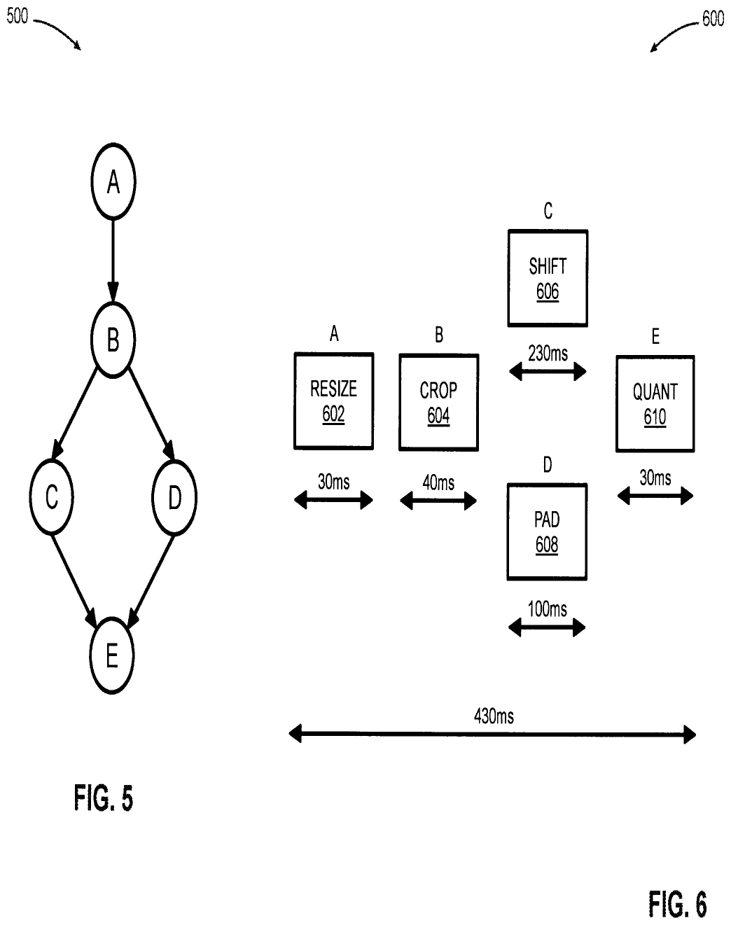

FIG. 5 is a task flow diagram depicting a task flow 500. As depicted, task flow 500 includes four tasks A, B, C, and D. In a task flow, tasks may be executed sequentially (i.e., in serial) and/or in parallel (i.e., concurrently). For example, tasks A and B are executed sequentially, while tasks C and D are executed in parallel, provided task dependency is not violated, and processing constraints (including hardware resources) are not violated.

If a stage/task ‘B’ precedes a stage/task “A”, this implies stage/task “A” executes before stage/task “B.” Then the types and format of outputs of stage/task “A” should match the types and formats of inputs of stage/task “B.”

When building a pipeline, pipeline processing architecture generator 118 verifies the inputs and outputs of each stage and auto-stitches the stages, so that data can flow through the pipeline seamlessly.

Task flow 500 can be representative of a set of tasks associated with a pipeline stage (e.g., preprocessing stage 106). Tasks that may be associated with preprocessing stage 106 may include tasks such as resize (task A, executed on a GPU), crop (task B, executed on a CPU), shift (task C, executed on a DSP), pad (task D), and quantize (task E). As depicted, task flow 500 is depicted as a graph.

FIG. 6 is an execution flow diagram depicting an execution flow 600. As depicted, execution flow 600 includes tasks associated with preprocessing 106. These tasks include resize 602 (task A in task flow 500), crop 604 (task B in task flow 500), shift 606 (task C in task flow 500), pad 608 (task D in task flow 500), and quantize 610 (task E in task flow 500). These tasks may respectively require 30 ms, 40 ms, 230 ms, 100 ms, and 30 ms to complete. The total completion time for preprocessing 106 adds up to 430 ms, taking into account the fact that tasks C and D execute in parallel, and that task C requires a longer period of time to complete as compared to task D.

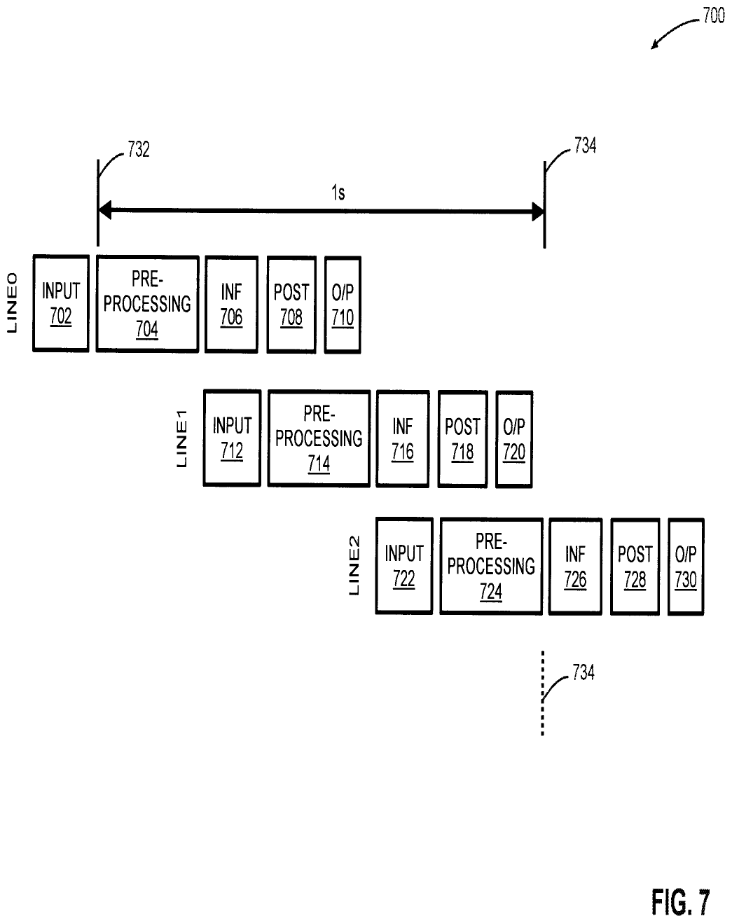

FIG. 7 is an execution flow diagram depicting a parallel execution flow 700. As depicted, parallel execution flow 700 includes three pipelines—line 0, line 1, and line 2. Line 0 includes stages input 702, preprocessing 704, inferencing 706, postprocessing 708, and output 710. Line 1 includes stages input 712, preprocessing 714, inferencing 716, postprocessing 718, and output 720. Line 2 includes stages input 722, preprocessing 724, inferencing 726, postprocessing 728, and output 730. Each pipeline and associated stages may be respectively similar to the pipeline depicted in flow 400.

In one aspect, pipeline line 1 input 712 starts at approximately the same time as inferencing 706, of line 0. Pipeline line 2 input 722 may start at approximately the same time as inferencing 716, of line 1. In one aspect, each of input 702, 712 and 722 may need 10 ms to complete; each of preprocessing 704, preprocessing 714, and preprocessing 724 may need 330 ms to complete; each of inferencing 706, 716, and 726, may need 200 ms to complete; each of postprocessing 708, 718, and 728 may need approximately 15 ms to complete; and each of output 710, 720, and 730 may need approximately 10 ms to complete.

Each pipeline stage (i.e., line 0, line 1, and line 2) may need approximately 565 ms to complete (end-to-end latency). A corresponding throughput for each inferencing stage may be 1/330 ms, or approximately 3 inferences per second. A total of 3 units of memory may be consumed, for a total of 6 active threads (1 for input/inference/postprocessing/output, and 2 for preprocessing), for each pipeline, for a total of three pipelines. In one aspect, a latency between a start time of preprocessing 704 and an end time of preprocessing 724 may be approximately 1 second. All three pipelines may be run in parallel.

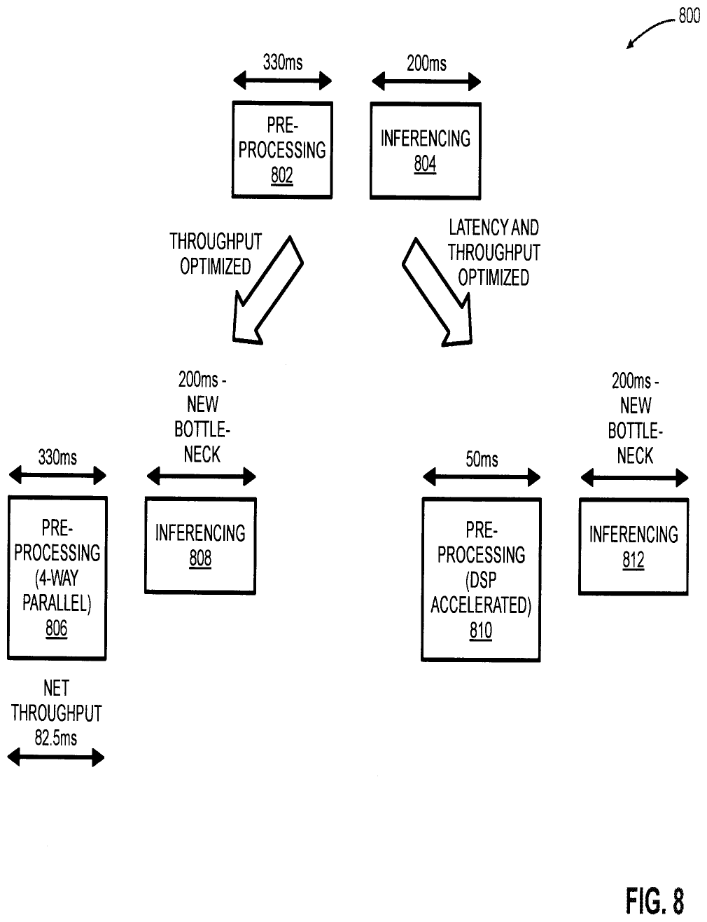

FIG. 8 is an execution flow diagram 800 depicting an improvement in execution time. Execution flow diagram 800 includes preprocessing 802 and inferencing 804 stages of a pipeline, with preprocessing 802 needing 330 ms to complete, and inferencing 804 needing 200 ms to complete. In this implementation, preprocessing 802 is the stage with the highest processing latency. These two stages can be substantially enhanced with respect to throughput, or with respect to latency and throughput. This enhancement may be implemented using pipeline processing architecture generator 118.

For throughput enhancement, a 4-way parallel preprocessing stage 806 may be implemented. 4-way parallel preprocessing stage 806 may split up processing tasks between four parallel processors, resulting in a fourfold reduction in throughput time. With this enhancement, a throughput time associated with 4-way parallel processing stage 806 takes 82.5 ms to complete (down from 330 ms). However, the latency associated with the 4-way parallel preprocessing stage 806 may still be 330 ms. Inferencing 808 still takes 200 ms to complete, and is now the stage with the highest processing latency in this implementation.

For latency and throughput enhancement, a DSP-accelerated preprocessing stage 810 may be implemented. DSP-accelerated preprocessing stage 810 may use DSP acceleration to bring down completion time of preprocessing 802 from 330 ms, to 50 ms when implemented as DSP-accelerated preprocessing stage 810. Inferencing 812 still takes 200 ms to complete, and is now the stage with the highest processing latency in this implementation.

In one aspect, the combination of 4-way parallel preprocessing stage 806 and inferencing stage 808 provides the following performance metrics:
End-to-end latency=565 ms (no change from the end-to-end latency associated with preprocessing stage 802 and inferencing stage 804).

Throughput= 1/200 ms=5 inferences/second

Memory consumed=5 units

Threads active =12

Pipeline count=5

In one aspect, the combination of DSP-accelerated preprocessing stage 810 and inferencing stage 812 provides the following performance metrics:
End-to-end latency =285 ms (improved from the end-to-end latency associated with preprocessing stage 802 and inferencing stage 804).

Throughput= 1/200 ms=5 inferences/second

Memory consumed=5 units

Threads active=5

Pipeline count=5

Both system architectures associated with 4-way parallel preprocessing 806 and

inferencing 808, and DSP-accelerated preprocessing 810 and inferencing 812 may be generated by pipeline processing architecture generator 118, and presented as implementation options to a user. The user can select with system design option best suits their needs, and can use the selected system design to build a target system for deployment.

A sequence for pipeline processing architecture generator 118 to generate one or more multiprocessor computing system architectures may include:
Pipeline processing architecture generator 118 receives a design specification for a multiprocessing system architecture. This multiprocessing system architecture may be configured to implement multiple processing pipelines and/or one or more use cases.
The design specification may include one or more constraints. For example, there may be a constraint on how much system memory is available for implementing the multi-pipeline processing system. Or, a user may wish to limit processor utilization to minimize power consumption on a battery-powered processing system.
Pipeline processing architecture generator 118 may generate one or more design metrics associated with the multiprocessing system architecture design based on the processing pipelines and the use cases. Examples of design metrics include latency, execution time, memory consumed, input/output data transfer time, inference time, and so on.
Pipeline processing architecture generator 118 may identify one or more performance degradation areas associated with one or more elements associated with the multiprocessing system architecture. For example, pipeline processing architecture generator 118 may identify degraded throughput as a performance degradation area.
Pipeline processing architecture generator 118 may generate one or more computing resource allocation (e.g., multiprocessor system architecture designs) based on the design metrics, the system constraints, and the performance degradation areas.
Pipeline processing architecture generator 118 may choose several different methods for constraint optimization-mathematical methods such as solvers or dynamic methods may be implemented, wherein several combinations of choices are tried out to determine an optimal solution that satisfies a set of constraints.

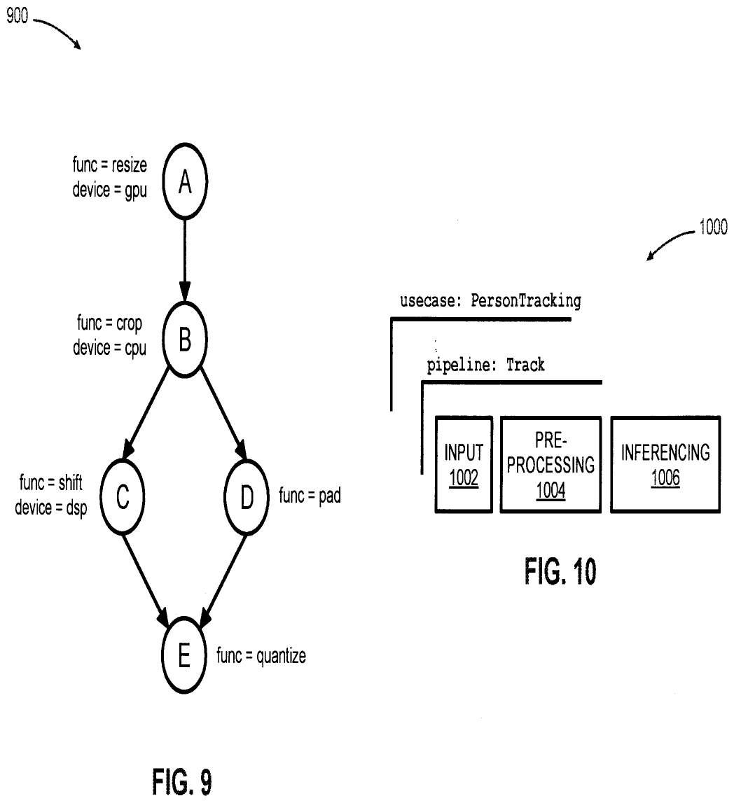

FIG. 9 is a task flow diagram depicting a task flow 900. Task flow 900 is a graphical rendition of a task flow, and may be used to provide a visual representation of a task flow associated with a pipeline processing stage. For example, task flow 900 may be associated with a sequence of tasks executed by preprocessing 106. As depicted, task flow 900 includes the following tasks:
Task A: Resize function, implemented on a GPU.
Task B: Crop function, implemented on a CPU.
Task C: Shift function, implemented on a DSP.
Task D: Pad function, can be implemented on a CPU.
Task E: Quantize function, can be implemented on a CPU.

In the task flow 900, tasks A and B are executed sequentially, (i.e., serially), while tasks C and D are executed concurrently (i.e., in parallel).

FIG. 10 is an execution flow diagram 1000 depicting an execution flow. Execution flow diagram 1000 depicts three pipeline stages—input 1002, preprocessing 1004, and inferencing 1006. These three pipeline stages may be associated with a pipeline design process being performed by a user. For example, pipeline processing architecture generator 118 may include a user interface that allows a user to design a processing pipeline using a drag-and-drop operation. During this design process, the user may specify a use case (specified as person tracking in execution flow diagram 1000), and a pipeline functionality (specified as track in execution flow diagram 1000). The user may drag-and drop each of the input 1002, preprocessing 1004, inferencing 1006, and other design blocks (i.e., pipeline stages) using the user interface (e.g., a visual design editor). For each design block, the user can specify a task flow. For example, the user may specify task flow 900 for preprocessing 1004.

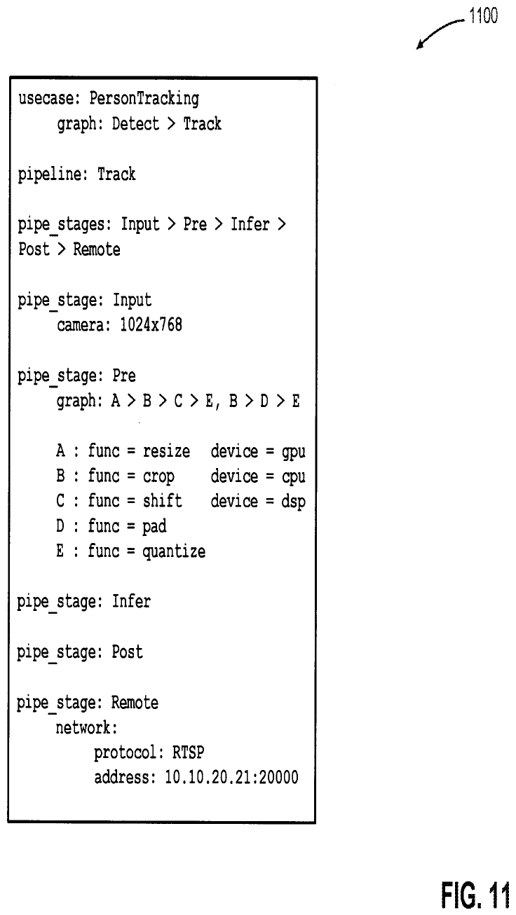

FIG. 11 is a schematic diagram depicting a domain-specific language (DSL) user interface 1100. DSL user interface 1100 may be used as an alternative to a visual drag-and-drop editor for specifying a pipeline architecture. A user may use DSL user interface 1100 to specify a pipeline architecture design using a domain-specific language. DSL user interface 1100 may include a parser and other tools that check user inputs for syntax errors and other errors.

As depicted, DSL user interface 1100 allows a user to specify a use case (e.g., person tracking). An associated graph may be used to specify that detection is executed before tracking. Pipeline stages (input, preprocessing, inference, postprocessing, and remote output) may be specified by the user. DSL user interface 1100 may also allow the user to specify a 1024×768 camera as an input source.

Using DSL user interface 1100, a user may be able to specify a task flow graph for one or stages, as required. As depicted, a user specifies a graph with the tasks in task flow 900, for the preprocessing stage. The user can specify a sequence of execution (A>B>C>E, B>D>E, consistent with task flow 900), a type of each function (e.g., task A is a resize function), and a processing platform for execution (e.g., task A is executed on a GPU). The remote (output) stage may be specified as a network that communicates using an RSTP protocol, at address 10.10.20.21:20000.

Pipeline processing architecture generator 118 may receive user inputs from DSL user interface 1100, and generate one or more multiprocessor system architectures based on the user inputs.

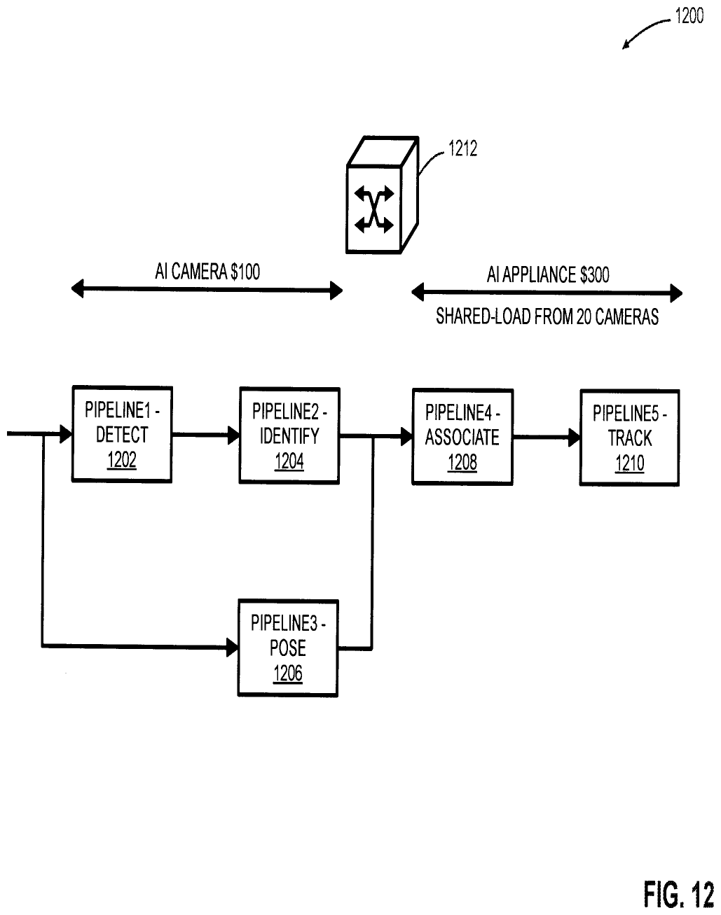

FIG. 12 is an execution flow diagram depicting an inference use case 1200. As depicted, inference use case 1200 includes three pipelines (i.e., a pipeline 1 1202, a pipeline 2 1204, and a pipeline 3 1206) associated with an AI camera that may cost $100. Pipeline 1 1202 may perform a detect (or detection) function on visual data (e.g., an image, an image stream, or a video stream) generated by the AI camera. Results from the detect function may be transmitted to pipeline 2 1204, which performs an identification function on the detected data. For example, pipeline 1 1202 may perform a face detection on the visual data, while pipeline 2 1204 may identify the detected faces. As depicted, pipeline 1 1202 and pipeline 2 1204 execute sequentially. Pipeline 3 1206 may perform pose detection on the visual data in parallel with the serial combination of pipeline 1 1202 and pipeline 2 1204.

Outputs from pipeline 2 1204 and pipeline 3 1206 may be transmitted over network 1212 (e.g., a local area network, wide area network, the Internet, etc.), to an AI appliance. In one aspect, the AI appliance costs approximately $300. The AI appliance may receive inputs from multiple (e.g., 20) cameras and implement a shared computing load. The AI appliance may implement pipelines pipeline 4 1208, and pipeline 5 1210. Pipeline 4 1208 may perform association operations on the different visual data streams received from the multiple cameras. For example, if multiple cameras image a space (e.g., a section of a store), then the different cameras may capture images of a person in the store from different angles. Pipeline 4 1208 may perform an association operation, to link together the identity of the person in the different video streams. Outputs from pipeline 4 1208 may be received by pipeline 5 1210. Pipeline 5 1210 may collectively track the identified person in all video streams.

In one aspect, a pipeline architecture to implement inference use case 1200 may be generated by pipeline processing architecture generator 118. Other possible system embodiments may include system architectures for processing data from an AI camera only, processing data from a camera without AI features (e.g., a “dumb” camera) using an AI appliance, and an AI camera and an AI appliance (as depicted in inference use case 1200).

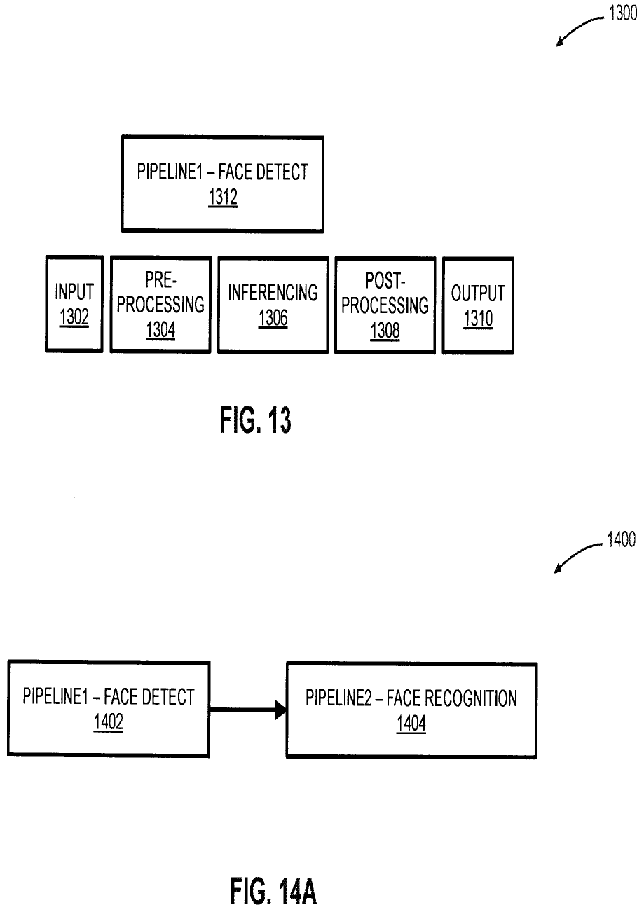

FIG. 13 is an execution flow diagram 1300 depicting a resource allocation. In one aspect, this resource allocation may be generated by pipeline processing architecture generator 118 in response to a system design request. As depicted, execution flow diagram depicts a pipeline 1 1312 to perform a face detection operation. Pipeline 1 1312 includes input stage 1302, preprocessing stage 1304, inferencing stage 1306, postprocessing stage 1308, and output stage 1310. These stages may be respectively similar to input 102, preprocessing 106, inferencing 108, postprocessing 112, and output 114.

In one aspect, pipeline 1 1312 executes a neural network application (NNApp) by gathering memory needs and latency of each node in an associated NNApp graph. The memory needs and latency may be determined by pipeline processing architecture generator 118 via one or more trial runs. Pipeline processing architecture generator 118 may automatically choose a system design configuration that most closely matches the design specification for the actual execution. For example, a system design configuration may be chosen to substantially maximize the throughput of the NNApp under user-defined system level resource constraints. Pipeline processing architecture generator 118 may include a constraint solver or may generate a system design configuration algorithmically/heuristically.

A constraint solver, when presented with a set of constraints expressed either as a mathematical formula or as a table of values for all the parameters in the expression, is able to apply several different techniques such as machine learning techniques (e.g., gradient boosting, XGboosting), manually coded targeted algorithms, or solvers (e.g., Integer linear programming based solver or SAT solver) or heuristics (practical methods to solve problems of this type that are unintuitive and may not necessarily give most optimal result). These techniques enable the constraint solver to determine one or more sets of parameter values that produces optimal results. Conversely, given a compute graph and associated constraints, pipeline processing architecture generator 118 may report suboptimal usage of resources.

As an example, pipeline processing architecture generator 118 may be presented with the following user budget:

1. Memory: 256 MB

2. Number of worker threads: 4

The system design may include the following objectives:

1. Minimize latency and maximize throughput

Statistics from firmware:

1. Memory required per pipeline—16MB

2. Latency of all stages (stages=4) are less than the IE (inference engine)

Based on these inputs, pipeline processing architecture generator 118 may generate the following result:

1. Num_lines required=4

2. Memory needed=4*16=64 MB

3. Memory saved for the system=192 MB

The algorithm uses the system constraints and trial run statistics to determine the recommended resources needed to maximize the objectives:

1. Determine Num_lines based on memory consumption per line:
#lines_1=Total_user_constraint_memory/per_line_memory_usage

2. Determine Num_lines based on the max latency stage of all the stages (other

than inference stage):
Determine if the stage is latency bound or not
   By executing subgraph using variable number of worker threads.
#lines_2=function (max_latency_stage, num_worker_threads_constraints,

inference_stage_latency)

3. Num_lines based on an inference latency and I/O times associated with the inference engine.
#lines_3=function (input_transfer_time, infer_time, output_transfer_time)

4. #Optimal_lines=min (#lines_1, #lines_2, #lines_3)

Based on #optimal_lines, the firmware provides feedback to the user about the

possible system performance degradation parameters (e.g., bottlenecks) from each section (stage), and suggestions on how to improve the throughput by adjusting the resource budget.

The algorithm to determine recommended resources is an improvement over the current state-of-the-art, as current solutions are based on manual back-of-the envelope calculations and some raw estimates before deploying. If the app graph changes, a user needs to go through the manual process all over again, which could get complicated, laborious, and time-consuming.

Other aspects of system designs generated by pipeline processing architecture generator 118 may include systems for source rate control. A methodology to automatically detect the maximum throughput an app (e.g., a pipeline processing architecture generated by pipeline processing architecture generator 118) can support for the given system constraints. The app can then dynamically control the input source rate (e.g., a camera) in case the maximum throughput achievable is unable to match the input rate. In doing so, unnecessary computation of dropped frames is reduced or/and there is less jitter in frames at the sink.

A similar methodology can be applied for multiple independent streams-each input stream can be dynamically rate controlled based on the pipeline statistics and user-provided system constraints. For example, in case the pipeline supports a maximum frame rate of 10 FPS and the input camera is at 40 FPS, the algorithm can drop source frames at 4:1 ratio to prevent, for example, any dropped frames.

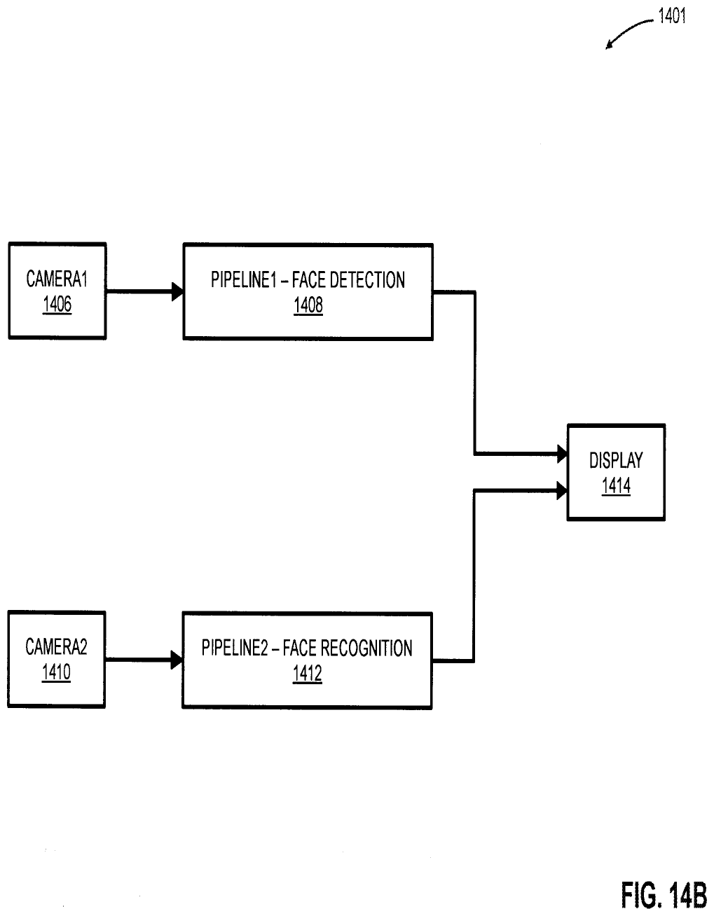

FIG. 14A is an execution flow diagram 1400 depicting a simulator application. As depicted, execution flow diagram 1400 includes pipeline 1 1402 serially connected to pipeline 2 1404. Pipeline 1 1402 may perform face detection in a video or photo stream. The face detection output from pipeline 1 1402 may be received by pipeline 2 1404. Pipeline 2 1404 may perform face recognition on the face detection data.

In one aspect, execution flow diagram 1400 may represent an execution flow implemented on a processing architecture generated by pipeline processing architecture generator 118. Pipeline processing architecture generator 118 may use this processing architecture to simulate a performance of the processing architecture. Results from the simulation may be presented to a user for evaluation. The user may use these results to determine whether the processing architecture is suitable for the user's needs.

The simulation methodology for simulating a use case graph associated with a processing architecture may provide approximate latency numbers for each task using performance benchmarks of the candidate system-on-chip (SOC). The simulation may determine whether the system configuration is ideal or not in terms of throughput.

Latency/throughput/compute requirements of the system can be simulated, and can be modified based on hardware constraints. The simulation process can be used as a methodology to help choose/compare SoC candidates for various end-to-end inference pipelines.

FIG. 14B is an execution flow diagram 1401 depicting parallel streams. As depicted, execution flow diagram 1401 includes camera 1 1406 connected to pipeline 1 1408. Execution flow diagram 1401 also includes camera 2 1410 connected to pipeline 2 1412. Pipeline 1 1408 may receive an image stream or a video stream from camera 1 1406, and perform face detection on the image stream or video stream. Pipeline 2 1412 may receive an image stream or a video stream from camera 2 1410, and perform face recognition on the image stream or video stream. Face detection outputs from pipeline 1 1408 and face recognition outputs from pipeline 2 1412 are output to display 1414.

Execution flow diagram 1401 is an example of a methodology to determine system resource allocation across parallel independent streams, such that the system resource allocation provides required system performance within requisite system constraints. In contrast, current solutions are based on equal distribution for each independent stream or back-of-the envelope calculations.

As an example, suppose a user's budget includes the following constraints:
Memory: 256 MB
#worker threads: 8
#streams: 2

Statistics from firmware:
Memory required for streams—[16, 32] MB
Latency of all stages are less than that of the inference engine per stream Result:
Num_lines required=[4, 4]
Memory needed=4*16+4*32=192 MB

Memory saved for the system=64 MB

The example above is representative of how pipeline processing architecture

generator 118 can generate a multiprocessing system design that reduces system resource allocation.

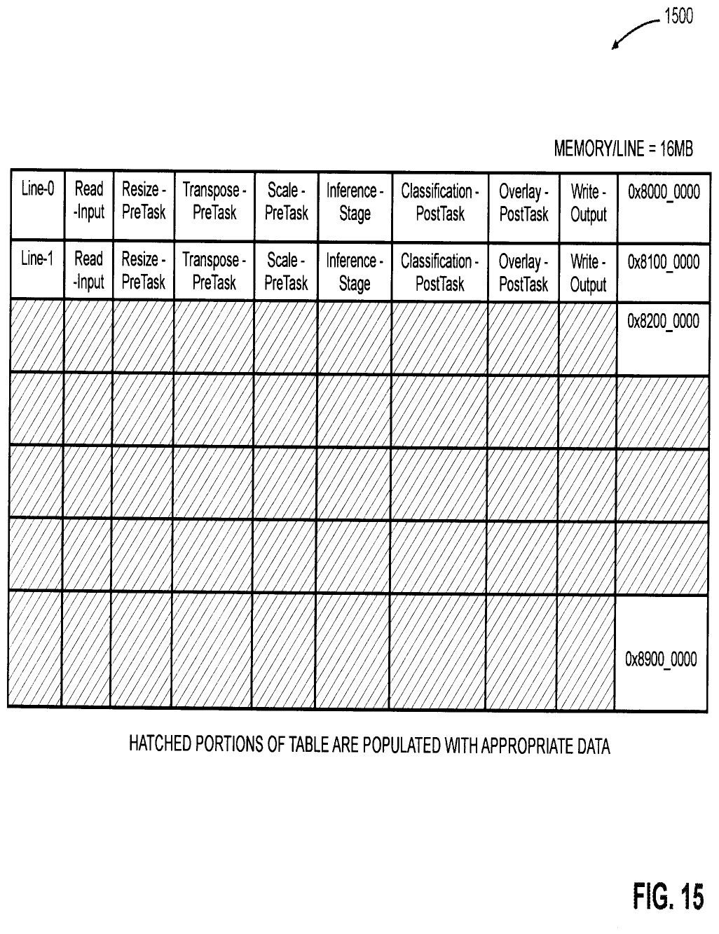

FIG. 15 is a schematic diagram depicting a memory allocation table 1500. As depicted, memory allocation table 1500 includes a memory allocation for each pipeline. Pipeline line 0 has an assigned memory address of 0x8000 0000. Pipeline line 1 has an assigned memory address of 0x8100 0000, and so on. In one aspect, memory allocation table allocates memory per line (pipeline). Memory allocation table 1500 may be generated by pipeline processing architecture generator 118 as a part of a static memory allocation process for a multiprocessing system design.

The memory allocation table design presents a methodology to statically allocate memory for each graph node in each pipeline so that app does not need to search or allocate memory during the actual execution and do round robin across lines. This aspect may be managed by memory manager 214.

In one aspect, pipeline processing architecture generator 118 may also perform memory collocation while generating a pipeline processing architecture design. Memory collocation allows reusing the data across tasks and avoid memory copy operations (memcpys) using colocation logic.

Requirement: In a multi-branch graph, a vertex node with more than one input edges would require the memory to be contiguous. The source nodes may produce the outputs in a scattered manner, where multiple memcpy operations would be needed to make the outputs contiguous. To address this problem, a colocation algorithm implemented by pipeline processing architecture generator 118 can parse through the graph and identify the graph patterns in the trail run and reduce the number memcpys required.

Example: In case of multi-input model inferences, typical inference engines need input tensors to be in a particular order and contiguous. These tensors may be independently generated by their previous tasks in non-contiguous memory location. In order to serve the inference, these tensors need to be arranged using memcpys in the required order.

Colocation: The colocation algorithm implemented by pipeline processing architecture generator 118 will understand this requirement in the trial run and automatically align the tensor output memories in the required order (and contiguous) in their respective tasks without the need for extra memcpys. This saves a memory bandwidth associated with the SOC.

Pipeline processing architecture generator 118 may also perform a load balancing operation. Pipeline processing architecture generator 118 may implement a methodology to load-balance the inference load across the Inference engines available in the system and automatically detects #parallel loads to pipeline the IO transfers. This methodology automatically detects an optimal number of IO slots to be placed inside the memory of the inference engines.

Representative performance figures are presented below:

Actual inference latency: 30 ms

Input transfer latency: 15 ms

Output transfer latency: 15 ms

With 1 thread: latency=60 ms

Throughput=16 FPS

Result with firmware:

Use three threads across 4 lines:

Avg latency=30 ms

Throughtput=33 FPS

In one aspect, pipeline processing architecture generator 118 functions based on:

Constraints:
Num_threads
Max Memory to be used (DRAM or SHM)

Objectives:
Substantially minimize system latency
Substantially maximize system throughput

Results:
Achieve the objective with optimal resources and hint back to increase

resources
Improve further, or hint back to decrease resource to release said resources for other system purposes.

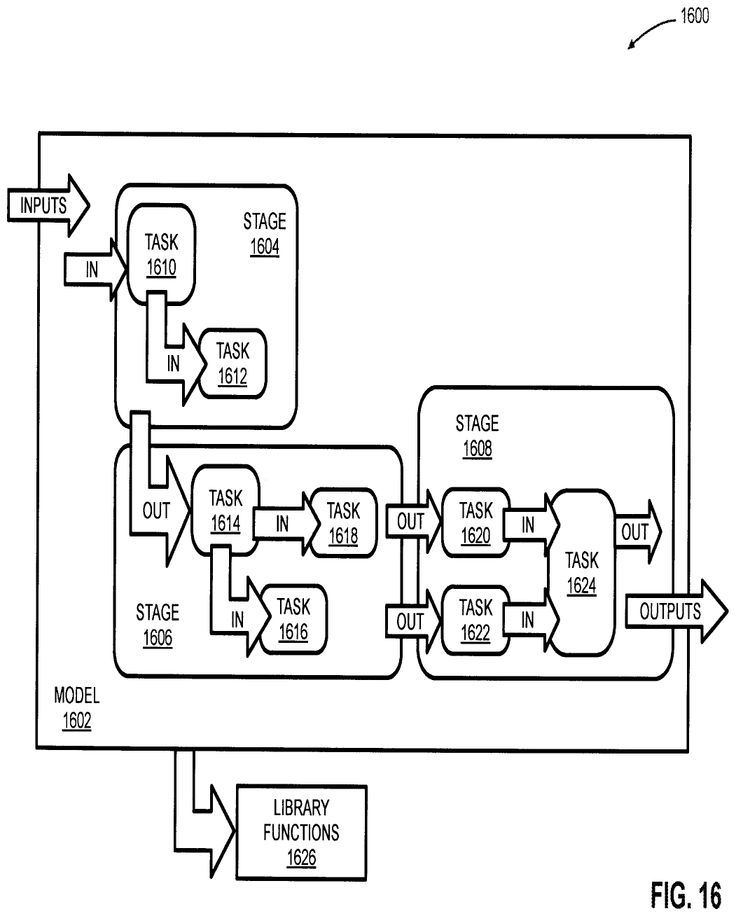

FIG. 16 is an execution flow diagram 1600 depicting multiple execution stages in a model 1602. Execution flow diagram 1600 depicts a data flow during pipeline execution. Model 1602 may be generated by pipeline processing architecture generator 118. As depicted, model 1602 includes stage 1604, stage 1606, and 1608. Stage 1604 includes task 1610 and task 1612. Stage 1606 includes task 1614, task 1616, and task 1618. Stage 1608 includes task 1620, task 1622, and task 1624. Model 1602 is an example model that may be generated by pipeline processing architecture generator 118.

In one aspect, model 1602 receives one or more inputs that are input to stage 1604. The inputs are processed by task 1610. The outputs of task 1610 are input to and processed by task 1612. Outputs generated by task 1612 are outputs generated by stage 1604, and received by task 1614 of stage 1606. Outputs generated by task 1614 are received by task 1616 and 1618, and processed in parallel. Task 1616 and task 1618 generate separate outputs that may be respectively processed by tasks 1620 and 1622, respectively. Outputs of tasks 1620 and 1622 may be processed by task 1624, which generates one or more outputs for model 1602. Model 1602 may also be associated with one or more library functions 1626. In one aspect, library functions 1626 are the actual implementations of the functions such as ‘Resize’ described herein.

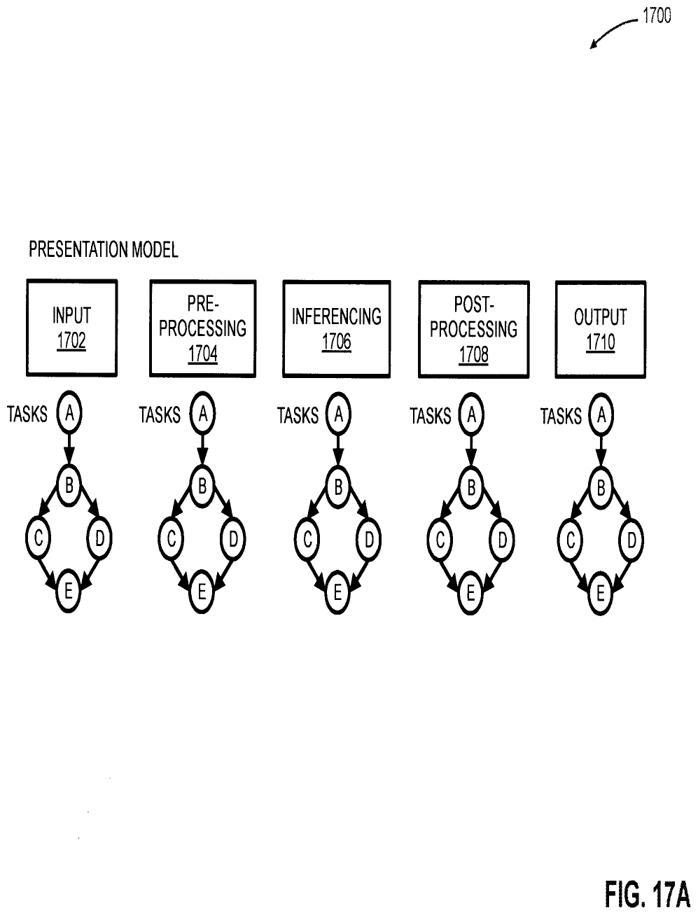

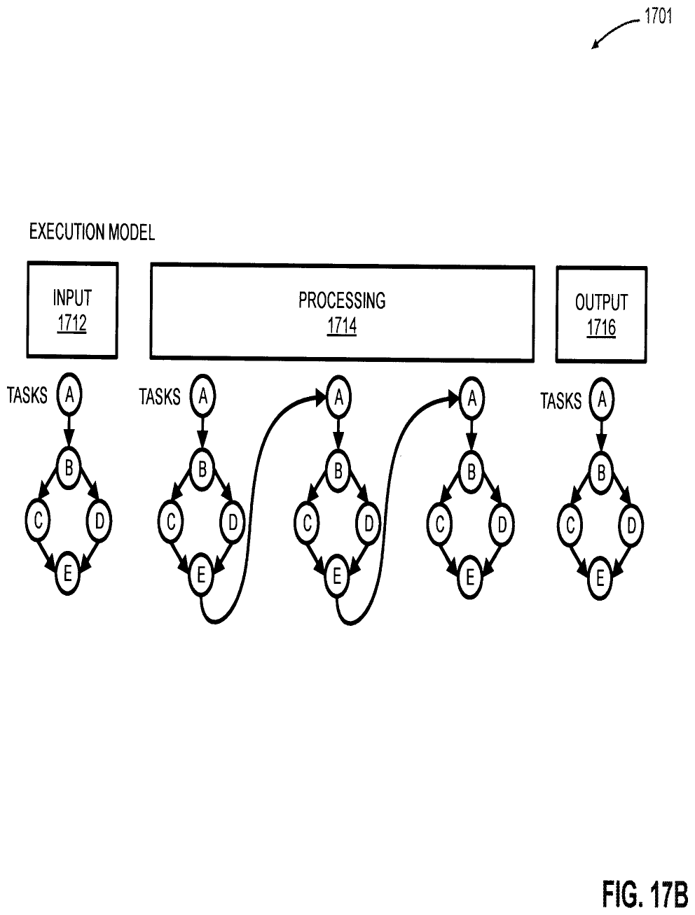

FIG. 17A is a schematic diagram depicting a presentation model 1700.

Presentation model 1700 may also be referred to as a “logical model.” As depicted, presentation model 1701 includes a pipeline with input stage 1702, preprocessing stage 1704, inferencing stage 1706, postprocessing stage 1708, and output stage 1710. Each stage has a set of tasks, with each set being generically represented with tasks A through E. A presentation model may be a user-defined model that is input to pipeline processing architecture generator 118. From a pipeline building perspective, pipeline processing architecture generator 118 allows the design of the pipeline with several stages, while reporting associated stage-level statistics. This helps a user to monitor the performance at stage level and isolate any areas of performance degradation (e.g., bottlenecks).

In one aspect, pipeline processing architecture generator 118 uses presentation model 1700 to generate execution model 1701 as presented in FIG. 17B. Execution model 1701 represents a pipeline that includes input stage 1712, processing stage 1714, and output stage 1716. Input stage 1712 and the corresponding tasks may be similar to input stage 1702 and the corresponding tasks. Output stage 1716 and the corresponding tasks may be similar to output stage 1710 and the corresponding tasks. Pipeline processing architecture generator 118 may combine preprocessing stage 1704, inferencing stage 1706, and post-processing stage 1708 into processing stage 1714. The task sequence for processing stage 1714 is identical to the task sequence for preprocessing stage 1704, inferencing stage 1706, and post-processing stage 1708.

Essentially, pipeline processing architecture generator 118 compiles the 5-stage pipeline depicted in FIG. 17A into a three-stage pipeline depicted in FIG. 17B, wherein the three-stage pipeline is comprised of input stage 1712 output state 1716, and processing stage 1714. It joins all the tasks in the three directed acyclic graphs (DAGs) in the pre-processing stage in to a single DAG of steps, while keeping the order of dependency intact. In one aspect, a DAG consists of vertices and edges. A graph that has edges with explicit direction and does not have a any loops i.e., acyclic is called a DAG. This mechanism enables 118 to join models and build higher order functionality.

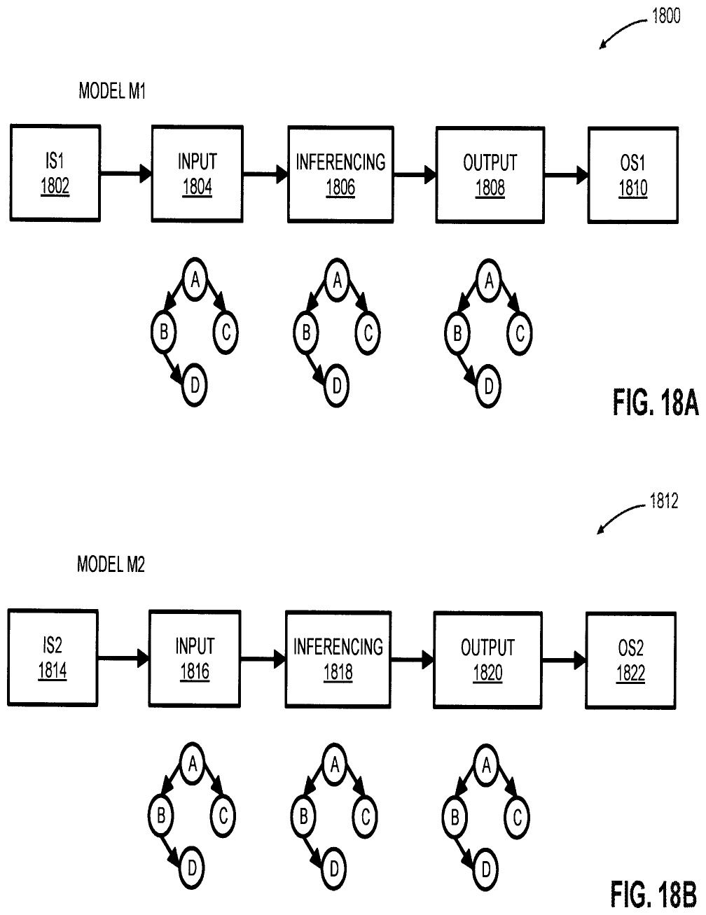

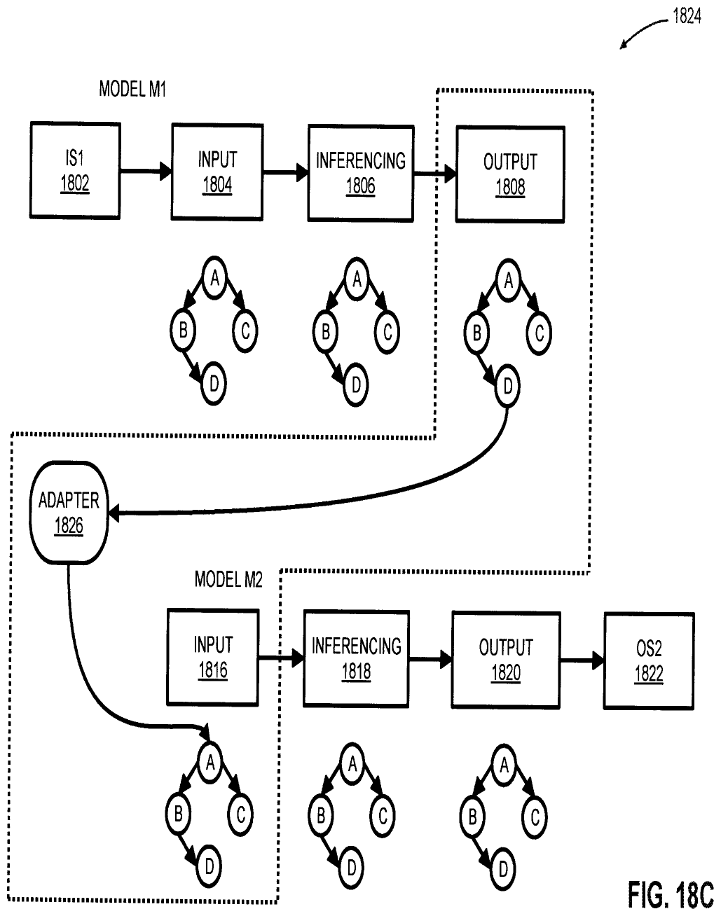

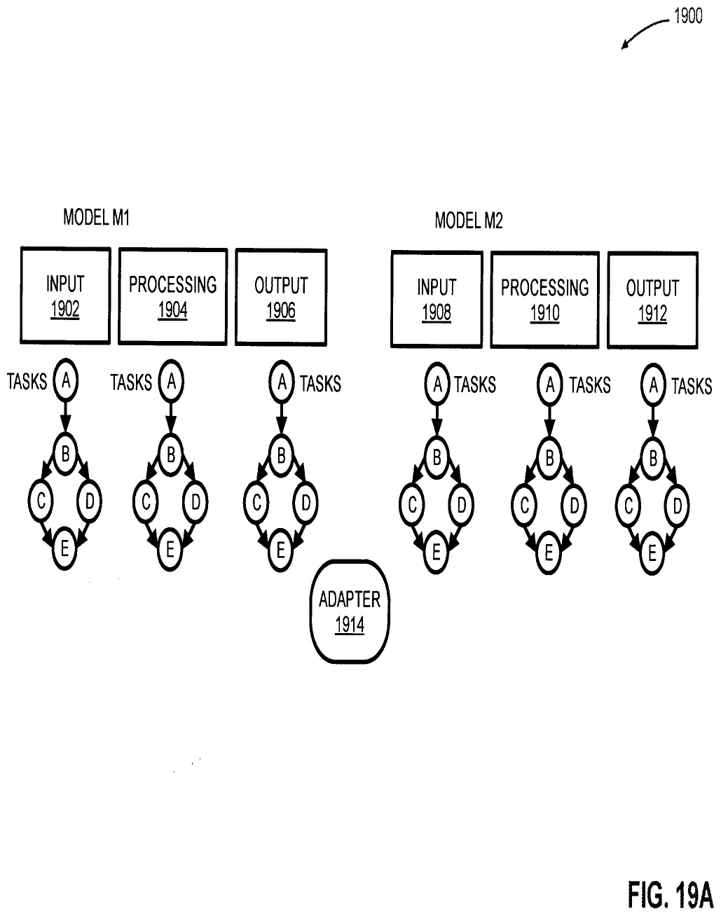

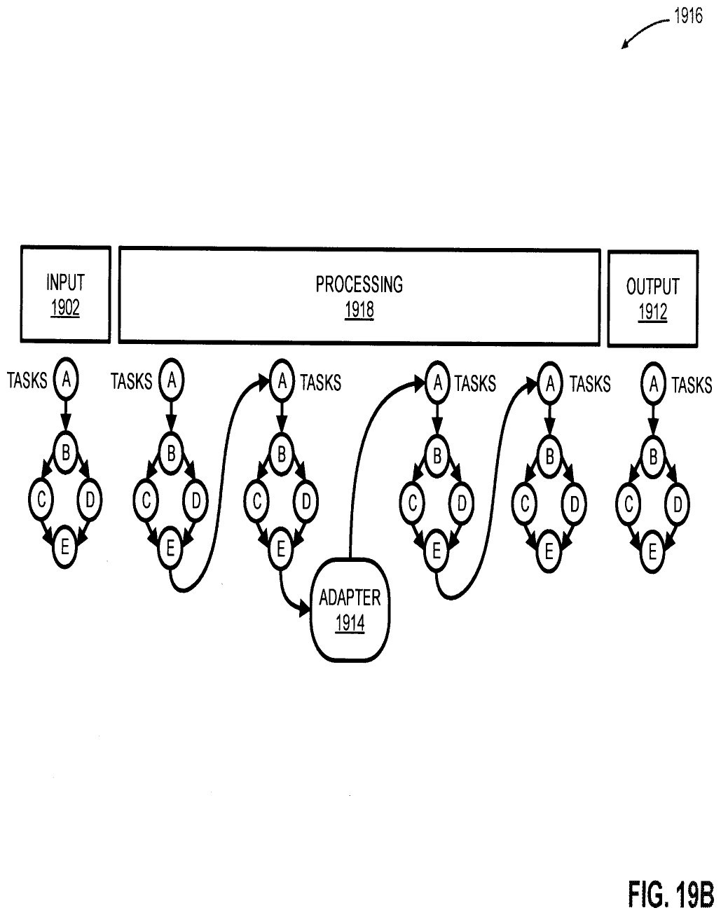

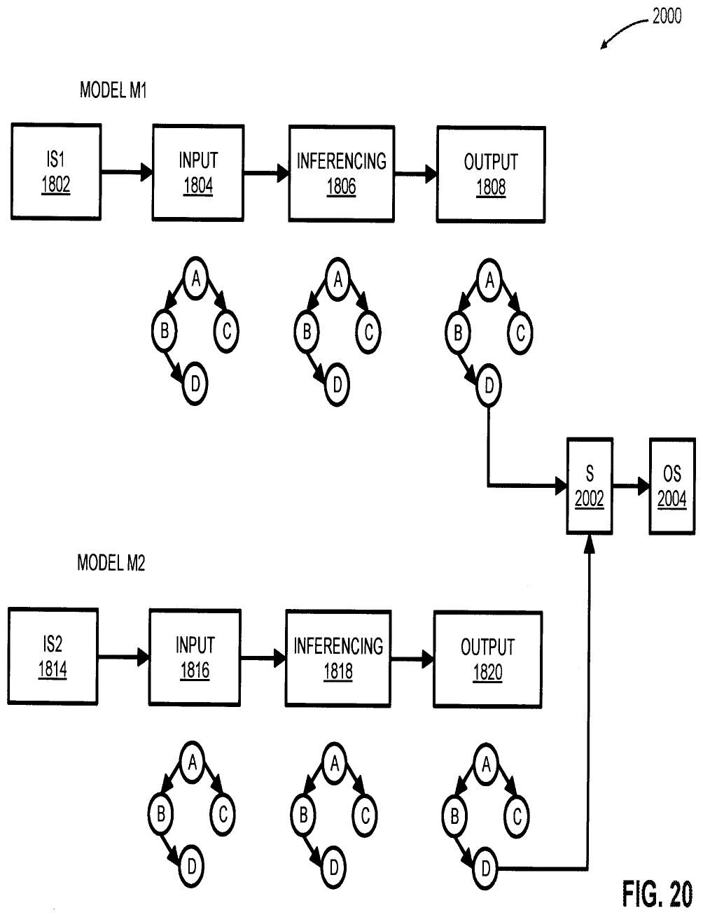

Pipeline processing architecture generator 118 may implement higher order functionality/complex use cases by joining one or more pipelines, based on user-defined models. In one aspect, pipeline processing architecture generator 118 facilitates reusing the models and build complex use cases and higher order functionality using the existing models. Pipelines may be joined in two ways: serial (depicted in FIGS. 18A through 18C, and FIGS. 19A and 19B), and parallel (depicted in FIGS. 20, 21A and 21B).

FIG. 18A is a schematic diagram depicting a presentation model 1800. Presentation model 1800 represents a pipeline model M1, with input source 1 1802, input stage 1804, inferencing 1806, output 1808, and output sink 1810. Each of input stage 1804, inferencing 1806, and output 1808 may have a set of tasks, with each set being generically represented with tasks A through D. Pipeline (presentation) model M1 1800 may be serially joined with another presentation model M2 1812, presented in FIG. 18B.

As depicted in schematic diagram 18B, presentation model 1812 includes input source 1 1814, input stage 1816, inferencing 1818, output 1820, and output sink 1822. Each of input stage 1816, inferencing 1818, and output 1820 may have a set of tasks, with each set being generically represented with tasks A through D.

FIG. 18C is a schematic diagram depicting a serially-merged presentation model 1824, comprising serially-merged pipeline models M1 1800, and M2 1812. The serial merging is accomplished by connecting output 1808 to input 1816 via adapter 1826. To implement the serial merging, a user may input models M1 1800 and M2 1812 into pipeline processing architecture generator 118. The user understands the models M1 1800 and M2 1812, and provides an adapter function 1826, which takes Model M1's outputs and connects them to model M2 inputs. Pipeline processing architecture generator 118 uses this adapter step to join the models M1 1800 and M2 1812 serially. The user may also invoke adapter 1826 by using the following join call to join the models in serial:

Adapter Step {M2_Input Adapter (M1_output)}

Join (SERIAL, Model M1, Model M2, adapter)

This sequence of calls joins the models M1 1800 and M2 1812 in a serial fashion, where M1 1812 precedes M2 1800 (M1>>M2).

In the above serial join process, the following commands may be used:

Join (SERIAL, M1, M2, Adapter)

Enum Join_Mode SERIAL

Adapter Step {M2_Input Adopter (M1_output)}

Using these commands, pipeline processing architecture generator 118 joins

models M1 1800 and M2 1812 serially, using the user-defined adapter functionality.

FIG. 19A is a schematic diagram 1900 depicting presentation models M1 1800 and M2 1812. Presentation model M1 1800 is depicted with alternate task graphs, with input 1902 being similar to input 1804, processing 1904 being similar to inferencing 1806, and output 1906 being similar to output 1808. Presentation model M2 1812 is depicted with alternate task graphs, with input 1908 being similar to input 1816, processing 1910 being similar to inferencing 1818, and output 1912 being similar to output 1820. Adapter 1914 may be used to serially merge presentation models M1 1800 and M2 1812. This serial merging is depicted in FIG. 19B.

FIG. 19B is a schematic diagram depicting a serially-merged execution model 1901. During the serial merging process, adapter 1914 serially connects processing stage 1904, output stage 1906, input stage 1908, and processing stage 1910, to form processing stage 1918. The tasks corresponding to these stages are also serially connected, as depicted in FIG. 19B. Specifically, a final task in a stage is connected to an initial task in a subsequent stage.

On a Join() call, the resultant pipeline will also have only three stages-the same as each of pipelines M1 1800 and M2 1812. The join call merges all step DAGs present in the stages between input stage of M1 1800 and output stage of M2 1812. While merging the DAGs, pipeline processing architecture generator 118 ensures that the order of dependency is maintained.

In one aspect, while performing a serial merge, dummy steps may be introduced. These dummy steps allow the identification the starting and ending of a DAG of each stage. If a DAG associated with a stage has multiple leaf nodes, a dummy node that precedes all sources may be used. If a DAG associated with a stage has multiple parent nodes, a dummy step succeeding all the parent nodes may be added. This enables marking a beginning and an end of each stage.

FIG. 20 is a schematic diagram 2000 depicting a pair of presentation models merged in parallel. Schematic diagram depicts model M1 1800 and model M2 1812 merged in parallel using sink S 2002. Sink 2002 combines outputs from model M1 1800 and model M2 1812, and transmits these combined outputs to output sink OS 2004.

A user can instruct pipeline processing architecture generator 118 to join two pipelines. This join operation receives outputs from all models (e.g., M1 1800 and M2 1812) as inputs and emits output(s) in the required form. Pipeline processing architecture generator 118 may implement a sink functionality (e.g., sink 2002) to join the models/pipelines in parallel. An example sequence of function calls to achieve a parallel join operation may be:

Sink Step {Output Sink (M1_output, M2_output, . . . )}

Join (PARALLEL, Model M1, Model M2, . . . , Sink)

In the background, compiling the pipeline to a three-stage pipeline will ease the process of joining the pipelines.

FIG. 21A is a schematic diagram 2100 depicting presentation models M1 1800 and M2 1812, and a sink 2114. Presentation model M1 1800 is depicted with alternate task graphs, with input 2102 being similar to input 1804, processing 2104 being similar to inferencing 1806, and output 2106 being similar to output 1808. Presentation model M2 1812 is depicted with alternate task graphs, with input 2108 being similar to input 1816, processing 2110 being similar to inferencing 1818, and output 2112 being similar to output 1820. Sink 2114 may be similar to sink 2002, and may be used to join M1 1800 and M2 1812 in parallel.

FIG. 21B is a schematic diagram depicting a parallel execution model 2116. Parallel execution model 2116 is a pipeline generated by combining presentation models M1 1800 and M2 1812 in parallel. Inputs 2102 and 2108 may be combined into input 2118; processing 2104 and 2110 may be combined into processing 2120; and outputs 2106 and 2112 may be combined into output 2112, in a parallel manner. Parallel execution model 2116 depicts individual task graphs from the presentation models M1 1800 and M2 1812 being executed in parallel. Sink 2114 may be used to join outputs of the individual pipelines at the final stage of parallel execution model 2116.

In one aspect, pipeline processing architecture generator 118 processes a join() call and merges the pipelines in a parallel manner. The resulting pipeline may have three stages.

As the pipelines are merged in parallel, the resulting DAG in each stage in the parallel execution model executes the DAGs from the original models in parallel. In one aspect, pipeline processing architecture generator 118 joins the DAGs of input and processing stages using a dummy node; however, a sink (e.g., sink 2002 or 2114) may be used to joining the DAGs of the respective output stages.

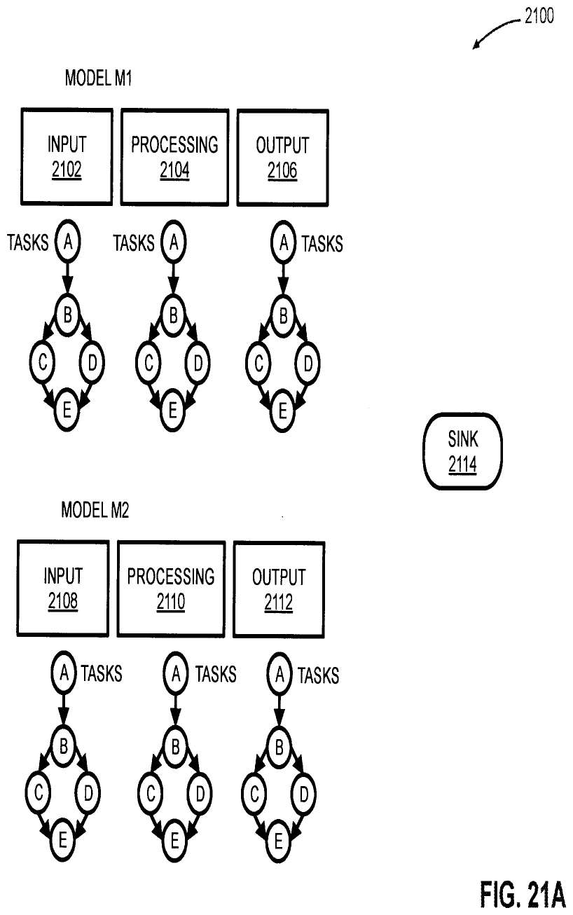

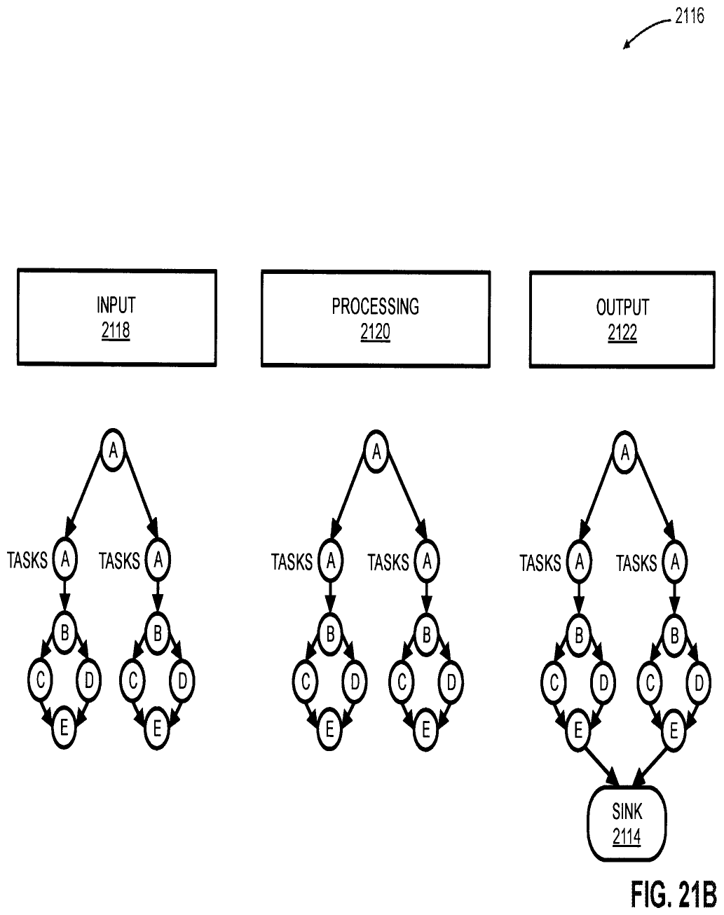

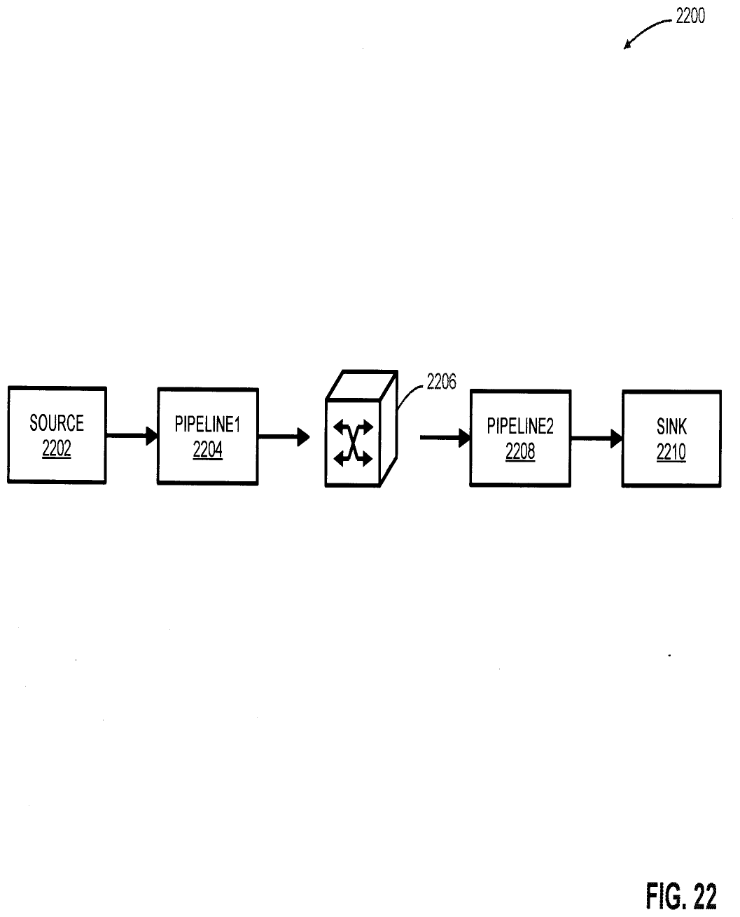

FIG. 22 is a block diagram depicting an execution flow over a network 2200. As depicted, execution flow 2200 includes source 2202, pipeline1 2204, network 2206, pipeline2 2208, and sink 2210. Execution flow 2200 can be used to implement one or more pipelines over network 2206. For example, source 2202 may be a camera, while pipeline1 2204 may perform face detection. Outputs from pipeline1 2202 may be transmitted over network 2206, and received by pipeline2 2208. Pipeline2 2208 may perform face recognition, and output the face recognition results to sink 2210. Sink 2210 may be a display. Both pipeline1 2204 and pipeline2 2208 may be instantiated by pipeline processing architecture generator 118. The instantiation may implement pipelines across systems connected over network protocol. The design process may include gathering statistics of network latencies associated with network 2206, and selecting processing platforms and network interfaces accordingly.

Pipeline processing architecture generator 118 may provide the following design tools:

Domain-specific language (DSL): Model building/specifying language, which can comprehensively specify the model functionality and pipeline. Pipeline processing architecture generator 118 may include a DSL compiler that generates the code for the given model specification in a DSL format compatible with pipeline processing architecture generator 118.

User interface UI): Pipeline processing architecture generator 118 framework provides a UI-based widget to compose pipelines. This framework provides drag-and-drop facilities of existing Steps/Stages and Models from the gallery. Behind the scenes, the framework validates the combination and generates the model specification using the pipeline processing architecture generator DSL.

Memory Management: A memory manager (e.g., memory manager 214) associated with pipeline processing architecture generator 118 understands the memory requirement patterns of the pipeline and allocates the memory best suitable for the pipeline execution. Memory manager 214 learns the memory allocation pattern during an essay phase of execution of the pipeline, and creates a map best suitable for a pipeline execution with possibly minimum memory use. Memory manager 214 then replicates the same memory allocation across all the execution lines of the pipeline. This mechanism helps memory manager 214 to avoid the allocation/deallocation of memory during the pipeline execution.

Apart from other memory management tasks memory manager 214 performs other tasks such as:
Creating a reusable memory for each pipeline line execution, so that a pipeline can be executed with the minimum possible memory.
Performing memory collocation: A colocation algorithm may be implemented based on memory constraints in an essay phase run, and automatically align tensor output memories in the required order (and contiguous) in their respective tasks without the need for extra memcpy() calls, saving SOC memory bandwidth.

Apart from these memory manager tasks, memory manager 214 can also it also hints the model to decide on the max scale factor.

Statistics: In one aspect, pipeline processing architecture generator 118 may include statistics 216 that provides deeper insights into pipeline execution, regarding resource consumption and performance. Pipeline processing architecture generator 118 may receive the execution time and memory requirements at every level of pipeline execution (e.g., at a step level, a stage level and a line level). These statistics help pipeline processing architecture generator 118 determine a maximum number of lines in a pipeline execution.

Analysis & Debugging Tools: In one aspect, pipeline processing architecture generator 118 provides logs to debug any concurrent issues that may arise during pipeline execution. In addition, pipeline processing architecture generator 118 may also provide a pictorial view of a pipeline execution. This tool provides can help a user in understanding and conceptualizing any issues arise during pipeline execution.

An algorithm implemented by pipeline processing architecture generator 118 may include a methodology to automatically detect a maximum throughput a system can achieve for a given set of system constraints. Pipeline processing architecture generator 118 may dynamically control the input source rate (e.g., a camera), in case an inference engine is unable to match the input rate. This reduces unnecessary computation of dropped frames, or to have better (continuity) in frames at the sink.

An algorithm implemented by pipeline processing architecture generator 118 may include a methodology to automatically detect optimal resources needed to obtain maximum efficiency for an application under user given system level resource constraints. Pipeline processing architecture generator 118 may provide options to a user to reduce the resources in if necessary.

FIG. 23 is a block diagram depicting an embodiment of a processing system 2302. Processing system 2302 may be used in embodiments of pipeline processing architecture generator 118. As depicted, processing system 2302 incudes communication manager 2304, memory 2306, system resource allocator, statistics collection module 2310, memory allocation module 2312, pipeline merging module 2314, processor 2316, user interface 2318, source rate control module 2320, memory management module 2322, memory co-location module 2324, and data bus 2326.

Communication manager 2304 can be configured to manage communication protocols and associated communication with external peripheral devices as well as communication with other components in pipeline processing architecture generator 118. For example, communication manager 2304 may be responsible for generating and maintaining a communication interface between pipeline processing architecture generator 118 and pipeline processing architecture 120.

Memory 2306 is configured to store data associated with pipeline processing architecture generator 118. Memory 2306 may include both long-term memory and short-term memory. Memory 2306 may be comprised of any combination of hard disk drives, flash memory, random access memory, read-only memory, solid state drives, and other memory components.

System resource allocator 2308 may function to allocate one or more system resources (e.g., CPUs, GPUs, memory, etc.) for a pipeline processing architecture design. System resource allocator may perform resource allocation functions based on one or more system-specific constraints (e.g., processor utilization, memory allocation, etc.).

Statistics collection module 2310 may be similar to statistics 216, and may collect the memory and CPU at task, stage and line levels associated with a pipeline. Data collected by statistics collection module 2310 comprises trial run statistics that are used in conjunction with system design constraints to determine the recommended resources needed to maximize the objectives. These statistics may also help pipeline processing architecture generator 118 determine a maximum number of lines in a pipeline execution.

Memory allocation module 2312 may be configured to perform memory allocation operations as described herein. Memory allocation module 2312 may generate a memory allocation table (e.g., memory allocation table 1500), allowing pipeline processing architecture generator 118 to statically allocate memory for each graph node in each pipeline.

Pipeline merging module 2314 may execute serial or parallel pipeline merging tasks. For example, pipeline M1 1800 and pipeline M2 1812 may be merged serially or in parallel by pipeline merging module 2314.

Processor 2316 is configured to perform functions associated with pipeline processing architecture generator 118. These functions may include generalized processing functions, arithmetic functions, and so on. Processor 2316 is configured to process information associated with the systems and methods described herein.

User interface 2318 allows a user to interact with aspects of the invention described herein. User interface 2318 may include any combination of user interface devices such as a keyboard, a mouse, a trackball, one or more visual display monitors, touch screens, incandescent lamps, LED lamps, audio speakers, buzzers, microphones, push buttons, toggle switches, and so on.

Source rate control module 2320 may be configured to perform operations related to source rate control, as described herein. Memory management module 2322 may be configured to perform memory management operations, such as to ensure that a multiprocessing system architecture is within any memory constraints specified by the multiprocessing system design specification.

Memory co-location module 2324 may be configured to perform memory collocation operations, as described herein. Data bus 2326 communicatively couples the different components of computing system 2302, and allows data and communication messages to be exchanged between these different components.

FIG. 24 is a flow diagram depicting a method 2400 to provide an execution model. Method 2400 may include identifying resource constraints for multiple computing devices (2402). For example, pipeline processing architecture generator 118 may identify resource constraints (e.g., processor utilization constraints, memory allocation constraints, etc.) associated with a multiprocessing computing system used to implement pipeline processing architecture 120.

Method 2400 may include creating multiple presentation models (2404). For example, pipeline processing architecture generator 118 may create multiple presentation models that meet design criteria while satisfying system design constraints.

Method 2400 may include using an inference engine to provide an execution model for the multiple processing pipelines (2406). For example, the multiple processing pipelines designed by pipeline processing architecture generator 118 may be converted into an execution model and executed on inferencing 108.

FIG. 25 is a flow diagram depicting a method 2500 to execute a neural network model. Method 2500 may include identifying resource constraints for multiple computing devices (2502). For example, pipeline processing architecture generator 118 may identify resource constraints (e.g., processor utilization constraints, memory allocation constraints, etc.) associated with a multiprocessing computing system used to implement pipeline processing architecture 120.

Method 2500 may include creating multiple presentation models (2504). For example, pipeline processing architecture generator 118 may create multiple presentation models that meet design criteria while satisfying system design constraints.

Method 2500 may include using an inference engine supporting neural network processing to execute a neural network model (2506). For example, the multiple processing pipelines designed by pipeline processing architecture generator 118 may be converted into an execution model and executed on inferencing 108. Inferencing 108 may support neural network processing, and the pipelines may be executed as neural network models.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A processing method for multiple computing devices, comprising:
identifying resource constraints for the multiple computing devices;
using identified resource constraints, creating multiple presentation models at least in part based on identified processing metrics, with the multiple presentation models including multiple processing pipelines configurable for execution on multiple computing devices; and
using an inference engine to provide an execution model for the multiple processing pipelines based at least in part on the multiple presentation models, with the execution model having improved processing metrics as compared to at least one of the multiple presentation models.

2. The method of claim 1, wherein the processing metrics include at least one of a latency, an execution time, a memory consumed, an input/output data transfer time, and an inference time.

3. The method of claim 1, further comprising generating user cases via a drag-and-drop visual editor.

4. The method of claim 1, further comprising generating one or more user cases via text input adherent to a domain-specific language.

5. The method of claim 1, wherein a processing pipeline further includes any combination of one or more computational stages such as an input stage, a preprocessing stage, a postprocessing stage, and an output.

6. The method of claim 1, wherein the inference engine can load and unload one or more neural network models generated from the presentation model by the neural network processing.

7. The method of claim 1, wherein one or more computing graphs associated with the presentation model are combined in any combination of sequential, parallel, and merged combinations.

8. The method of claim 7, wherein the combination is used to create one or more additional presentation models.

9. The method of claim 7, wherein the computing graphs are split so as to be executed on multiple compute devices attached to a network.

10. The method of claim 1, wherein the inference engine segregates processing pipelines in stages.

11. An apparatus comprising:
a plurality of computing devices; and
a pipeline processing architecture generator configured to:
identify resource constraints for the computing devices;
using identified resource constraints, create multiple presentation models at least in part based on identified processing metrics, with the multiple presentation models including multiple processing pipelines configurable for execution on multiple computing devices; and
use an inference engine to provide an execution model for the multiple processing pipelines based at least in part on the multiple presentation models, with the execution model having improved processing metrics as compared to at least one of the multiple presentation models.

12. The apparatus of claim 11, wherein the processing metrics include at least one of a latency, an execution time, a memory consumed, an input/output data transfer time, and an inference time.

13. The apparatus of claim 11, further comprising generating user cases via a drag-and-drop visual editor.

14. The apparatus of claim 11, further comprising generating one or more user cases via text input adherent to a domain-specific language.

15. The apparatus of claim 11, wherein a processing pipeline further includes any combination of one or more computational stages such as an input stage, a preprocessing stage, a postprocessing stage, and an output.

16. The apparatus of claim 11, wherein the inference engine can load and unload one or more neural network models generated from the presentation model by the neural network processing.

17. The apparatus of claim 11, wherein one or more computing graphs associated with a presentation model are combined in any combination of sequential, parallel, and merged combinations.

18. The apparatus of claim 17, wherein the combination is used to create one or more additional presentation models.

19. The apparatus of claim 17, wherein the computing graphs are split so as to be executed on multiple compute devices attached to a network.

20. The apparatus of claim 11, wherein the inference engine segregates processing pipelines in stages.
